(19) United States
(12) Patent Application Publication
(10) Pub. No.: US 2016/0290701 A1
(43) Pub. Date: Oct. 6, 2016

(54) Mitigating global warming by OTEC-induced ocean upwelling

(71) Applicant: Alan Kleinfeld Miller, Santa Cruz, CA (US)

(72) Inventor: Alan Kleinfeld Miller, Santa Cruz, CA (US)

(21) Appl. No.: 15/082,354

(22) Filed: Mar. 28, 2016

Related U.S. Application Data
(60) Provisional application No. 62/139,911, filed on Mar. 30, 2015.

(51) Int. Cl. F25D 1/02; A01G 15/00

(52) U.S. Cl. CPC F25D 1/02; A01G 15/00

(57) ABSTRACT

This invention mitigates global warming substantially by combining elements from two separate fields in a novel way. It is based on the discovery that the volumetric rate of cold water upwelling that will result in a 1.08 C reduction in the Earth's Surface Air Temperature (SAT) is similar to the volumetric rate of cold water upwelling that would be produced by roughly 20,000 OTEC plant-ships of 400 MW size each. These can generate 7 terawatts of electric power converted to an ammonia energy carrier and shipped to on-land locations, where can be “cracked” and burned as CO2-free fuel for power plants. The large reduction in SAT enables proposal of an affordable financial strategy that would pay most of the costs of the system out of the revenue from CO2 emission allowances granted by governing agencies for alternative energy systems that also cause a direct reduction in SAT.

### FILING DATE OF PROVISIONAL APPLICATION

U.S. provisional application No. 62/139,911 was filed on Mar. 30, 2015

### BACKGROUND

Global warming is the most serious problem facing humanity. FIG. 1 (ref. 1) summarizes some of its consequences. In late 2015, 187 nations of the world signed the COP 21 accords in Paris (ref. 2) recognizing that action needs to be taken in order to limit global warming to 2 C (or better) to avoid catastrophic consequences. However the best scenario they could agree to (the Intended Nationally Determined Contributions, or INDC scenario, FIG. 2, 3) will still allow global warming to reach 2.6 C by 2100 (FIG. 2). This will occur despite carbon emissions being reduced to 23% of baseline levels by 2100 [FIG. 4 (ref. 3) and FIG. 5 (ref. 4)] largely by increased use of non-biomass renewable energy (e.g. wind and solar) along with nuclear energy (FIG. 6).

This invention is a new technical and financial strategy which could hold global warming to about 1.52 C within the INDC carbon emissions reductions already agreed to at COP21, at about half the capital cost under INDC, and at a delivered electricity price similar to current prices. If implemented, this invention would constitute a major breakthrough in mitigating global warming to safer levels.

### BRIEF SUMMARY OF THE INVENTION

This invention consists of the process of using large quantities of cold water upwelled by an environmentally-acceptable number of Ocean Thermal Energy Conversion (OTEC) “grazing” plants for the specific purpose of achieving a direct and substantial reduction of the Earth's Surface Air Temperature (SAT) relative to what the SAT would be without use of this process. The reduction in SAT due to cold water upwelling has been calculated by an Earth Systems Model of the type that climatologists now use to predict such behaviors. For example, upwelling equivalent to that from 20,308 OTEC grazing plants at 400 MW each is predicted to produce a reduction in the Earth's SAT of 1.08 degrees C. (relative to what it would be otherwise, and not including the effect of the reduction of CO2 emissions when fossil-fueled electricity is replaced by OTEC-generated electricity). This relatively large reduction in temperature is believed to arise because the cold water upwelling triggers natural forces which multiply the effects of the upwelling by means of a positively signed temperature-sea ice-albedo feedback loop. The reduction in SAT extends over the polar regions and therefore a major benefit should be both a slowing in gradual melt of land ice (which contributes substantially to gradual sea level rise) and a reduction in the chances for catastrophic sliding of large masses of land ice into the sea (which would cause a correspondingly rapid rise in sea level). This invention, if implemented, would ameliorate other detrimental effects of global warming as well. Consideration of the expected environmental effects of this large number of open ocean OTEC plants indicates no “show-stoppers” though further analysis and evaluation are certainly needed.

No invention is worthwhile in the practical sense if its cost is too high for implementation. In this case, the direct reduction in SAT enables a financial strategy that could allow implementation of the invention at a capital cost that is lower than all other known approaches to the same problem, and lower than what the nations of the world expect to spend. Accordingly, a specific best mode of implementation of the invention is described here, along with the financial strategy to get that mode implemented.

The financial strategy capitalizes on the predicted reduction in SAT to enable the governmental agencies that control CO2 emissions to award CO2 emission allowances to companies who implement alternative energy technologies which also produce direct reduction in Earth temperature. These emission allowances would be sold on the carbon credit markets to continued emitters of CO2, thereby raising most of the funds for construction of the OTEC system. With this financial strategy and using currently available estimates of costs for the major elements, the current estimate from an analysis of the technical and financial elements is that in addition to mitigating global warming by an additional 1.08 degrees C., the invention could save about $1.5 trillion compared to the next-best alternative in meeting the INDC commitments, and about $2.2 trillion compared to the INDC expected costs for renewable energy electricity. This should be a powerful additional incentive for implementation, on the part of both the governmental regulatory agencies that will have to provide the CO2 emission allowances, and private industry that will be able to earn a profit implementing the system.

### BRIEF DESCRIPTION OF THE DRAWINGS

This patent or application file contains at least one drawing executed in color, because many of the charts that illustrate the behavior are color contour maps (for example, FIGS. 8, 21) or plots from various literature sources that use color graphics.

FIG. 1 lists the major known consequences of global warming

FIG. 2 shows key elements of the INDC scenario agreed upon at the Paris climate talks of 2015

FIG. 3 shows further details of the INDC scenario

FIG. 4 shows that the INDC scenario is very similar to the climate scientists RCP4.5 scenario in terms of expected global warming and CO2 emissions level in 2030

FIG. 5 shows that the INDC scenario is similar to the more specific RCP 4.5 MINICAM level 2 scenario

FIG. 6 shows the expected sources of electricity under the RCP 4.5 MINICAM level 2 scenario

FIG. 7 shows how OTEC generates energy from the natural vertical temperature differences in the ocean

FIG. 8 illustrates the large regions of the world's oceans where OTEC is economically viable

FIG. 9 shows the concept of near-shore anchored OTEC plants that can provide baseline electricity for on-shore needs

FIG. 10 shows that OTEC Cold Water Pipes are huge, and upwell cold water at a huge volumetric rate

FIG. 11 illustrates OTEC “grazing” plants that can be far from shore in the tropics, and generate energy carriers in the useful form of transportation fuels

FIG. 12 shows further details of OTEC grazing plants including their ability to produce fresh water

FIG. 13 shows that the ammonia produced on OTEC grazing plants and transported to shore by tanker can also be distributed on land by ammonia pipelines.

FIG. 14 shows that OTEC grazing plants operating at a total upwelling rate of 5 m/yr can produce stable net power on the order of 7-10 TW.

FIG. 15 shows that at 28% conversion in the work cited, the burning velocity of a NH3/H2 mixture is similar to natural gas

FIG. 16 shows that at 45% conversion in the work cited, the burning velocity of a NH3/H2 mixture is similar to natural gas and is higher than bituminous coal

FIG. 17 shows that coal-burning power plants can be converted to burn gaseous fuels

FIG. 18 illustrates Ruthenium catalyst-based cracking equipment which is not a practical cracking technology for large-scale utilization

FIG. 19 shows the behavior of new low-cost ammonia cracking catalysts

FIG. 20 shows that NOx and NH3 emissions from NH3/H2 combustion can be made acceptable by using a flameholder and a wet scrubber

FIG. 21 shows that upwelling water from a depth of 1000 m at an average upwelling velocity of 1 cm/day over all biologically-suitable areas results in a very substantial lowering of the Earth's surface atmospheric temperature

FIG. 22 shows that artificial upwelling results in a lowering of the Earth's surface atmospheric temperature by 1.08 degrees C. at year 2100, with most of that achieved at 10 years.

FIG. 23 shows that ocean upwelling reduces the surface air temperature by a large amount per unit CO2 taken out of the atmosphere

FIG. 24 shows that there is a linear relationship between the total upwelling rate and the reduction in Earth surface air temperature, up to about 80,000 OTEC plants at 100 MW each (8 TW of OTEC power)

FIG. 25 shows that the “knee of the curve” is at about 1 cm/day

FIG. 26 provides an interpretation of why artificial upwelling produces a large quick change in SAT, not associated with a large change in atmospheric CO2

FIG. 27 compares the Keller et al Earth Systems Modelling artificial upwelling results against the cold water upwelling associated with the Nihous et al OTEC energy calculations, to show that deployment of 81,231 OTEC plants (if 100 MW each) will lower the Earth's SAT by 1.08 C

FIG. 28 summarizes the potential environmental impacts of OTEC

FIGS. 29 and 30 show that there is a net sequestration (not a release) of carbon, especially for watts upwelled from 1000 m depth

FIG. 31 shows that the predicted decrease in pH brought about by the upwelling from 7 TW of OTEC plants is small compared to the ocean acidification already underway

FIG. 32 summarizes the concerns on the environmental impacts of OTEC cold water intakes.

FIG. 33 shows some other side effects, and also summarizes that there are certainly environmental impacts of OTEC grazing plants used in an artificial upwelling mode, but there do not appear to be any show-stoppers among them

FIG. 34 shows data (from various UN IPCC scenarios) that is used in correlating atmospheric temperature increases against atmospheric CO2 content

FIG. 35 shows that the 1.08 degree C. atmospheric cooling induced by OTEC grazing plants is equivalent to a reduction in atmospheric CO2 of 2, 2,261 GtCO2e

FIG. 36 shows as an example the US EPA precedent for awarding CO2 emission allowances as incentives to entities that help mitigate global warming to a greater extent than required by carbon caps

FIG. 37 illustrates the strongly rising expected trend in carbon prices

FIG. 38 shows the results of US government calculations on the Social cost of carbon

FIG. 39 shows the major elements present in the preliminary computer model which analyzes the technical and financial behavior of the system

FIGS. 40 and 41 show output from the model for two different assumptions on electricity price.

FIG. 42 shows the calculated bottom-line benefits of this approach as analyzed with the preliminary computer model of the technical and financial elements

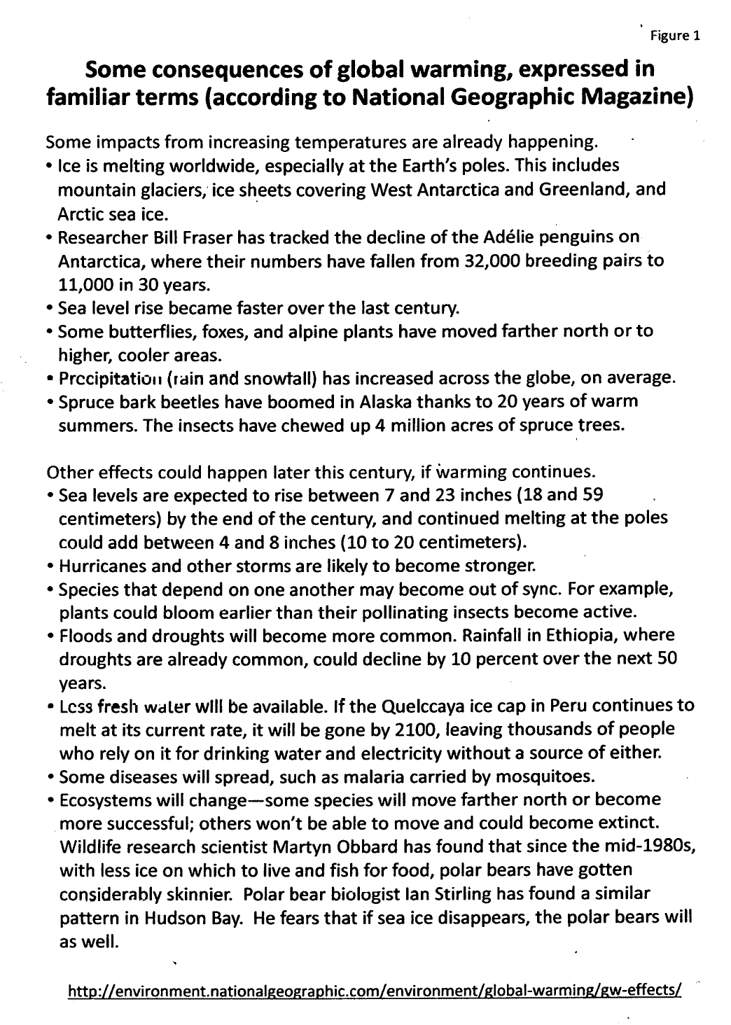

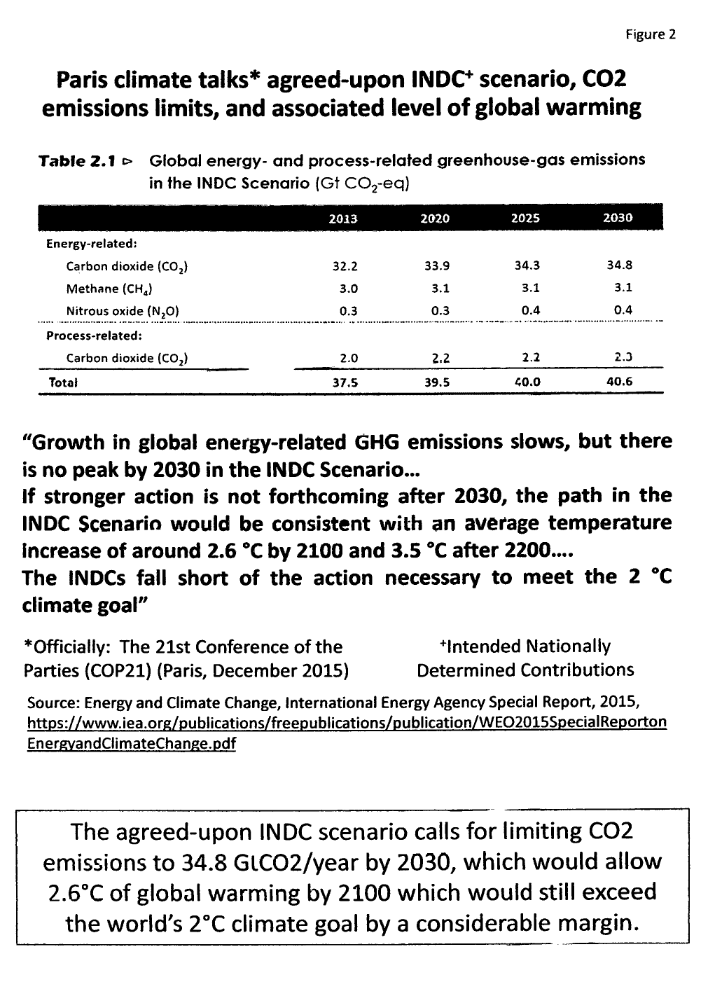

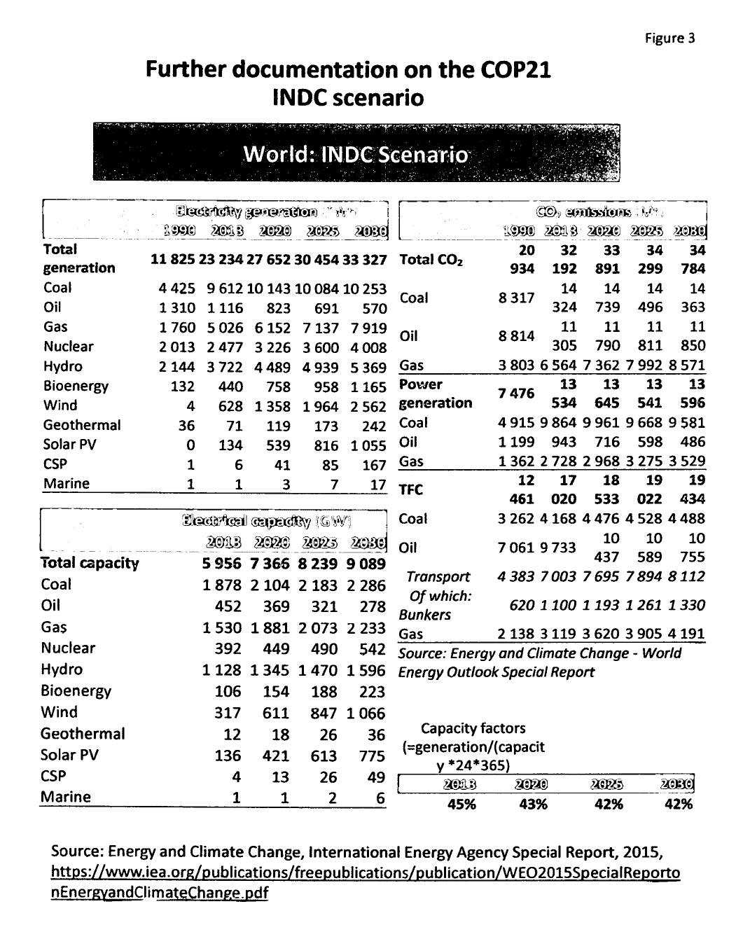

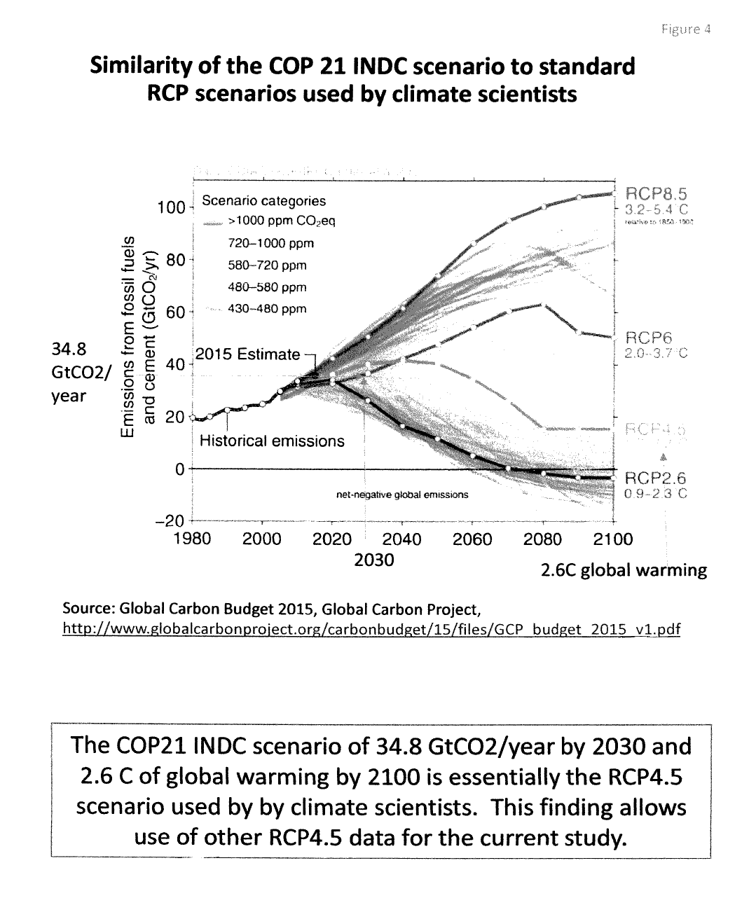

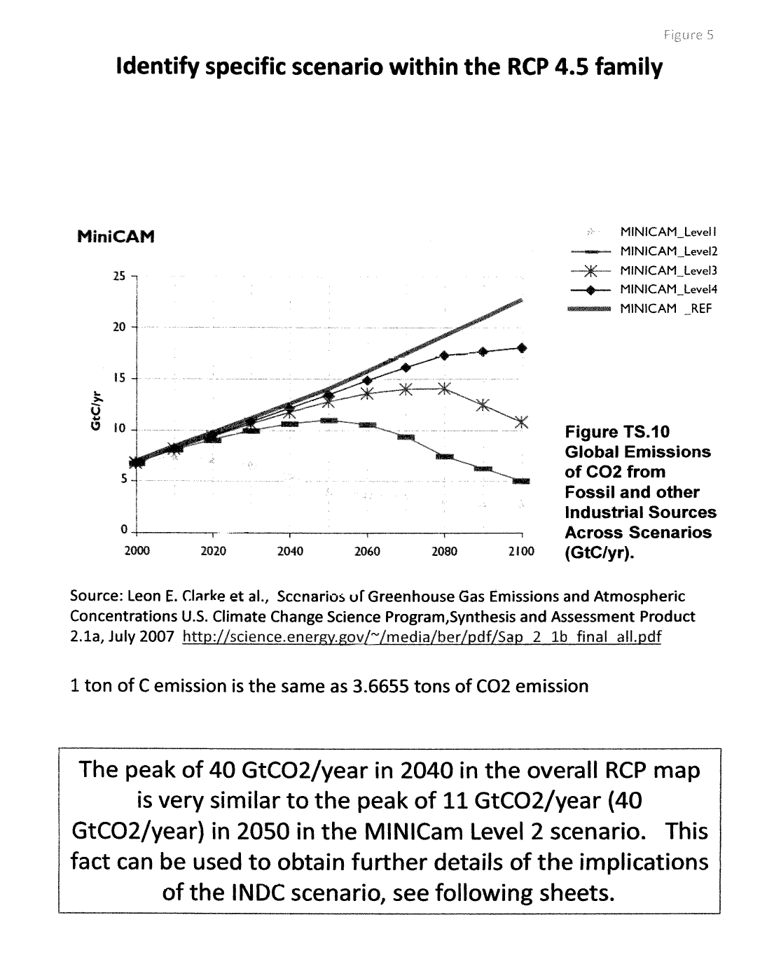

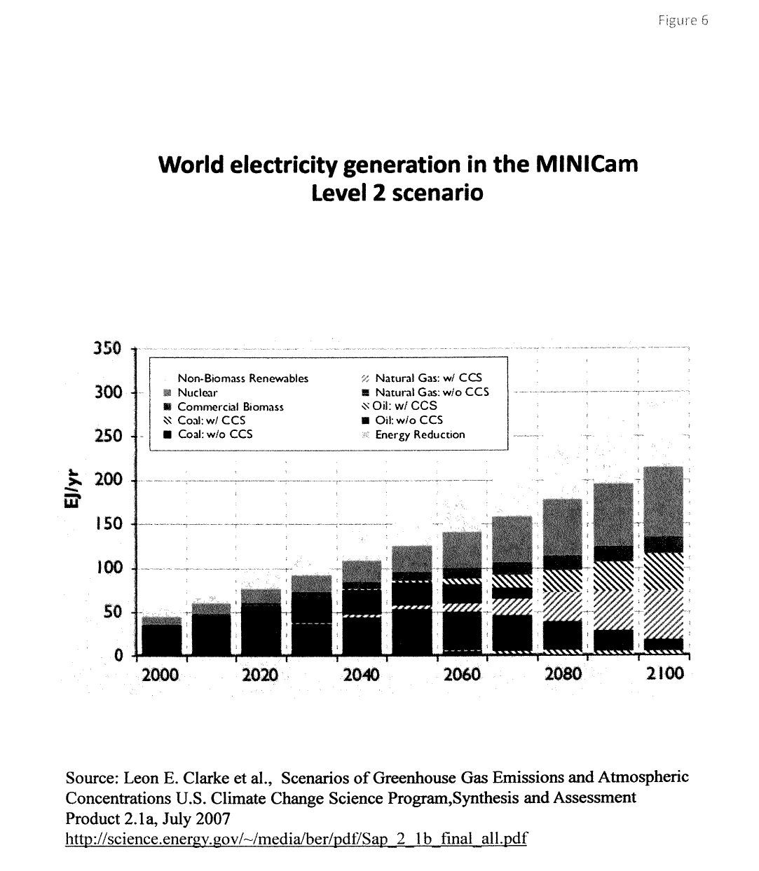

### DETAILED DESCRIPTION, BEST MODE OF IMPLEMENTATION, AND ANALYSIS OF THE BEHAVIOR OF THE SYSTEM

This invention consists of the process of using large quantities of cold water upwelled by an environmentally-acceptable number of Ocean Thermal Energy Conversion (OTEC) open ocean “grazing” plants for the specific purpose of a direct and substantial reduction of the Earth's Surface Air Temperature (SAT) relative to what the SAT would be without this process being implemented.

A. Description of the OTEC Process and How it can Generate Large Quantities of Dispatchable CO2-Free Electricity in Central Power Plants Located wherever Needed

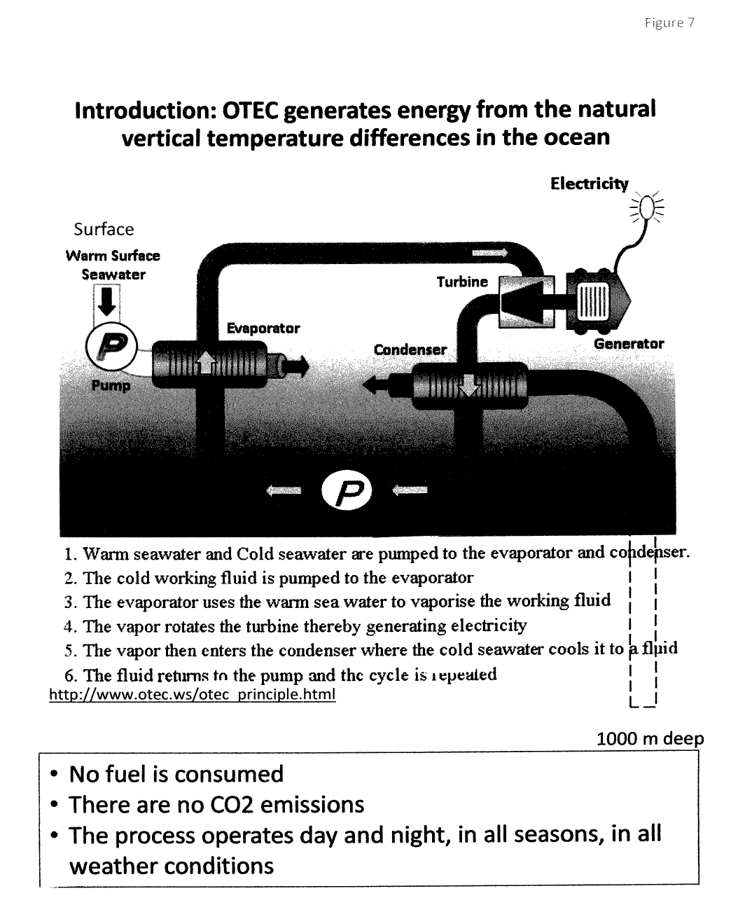

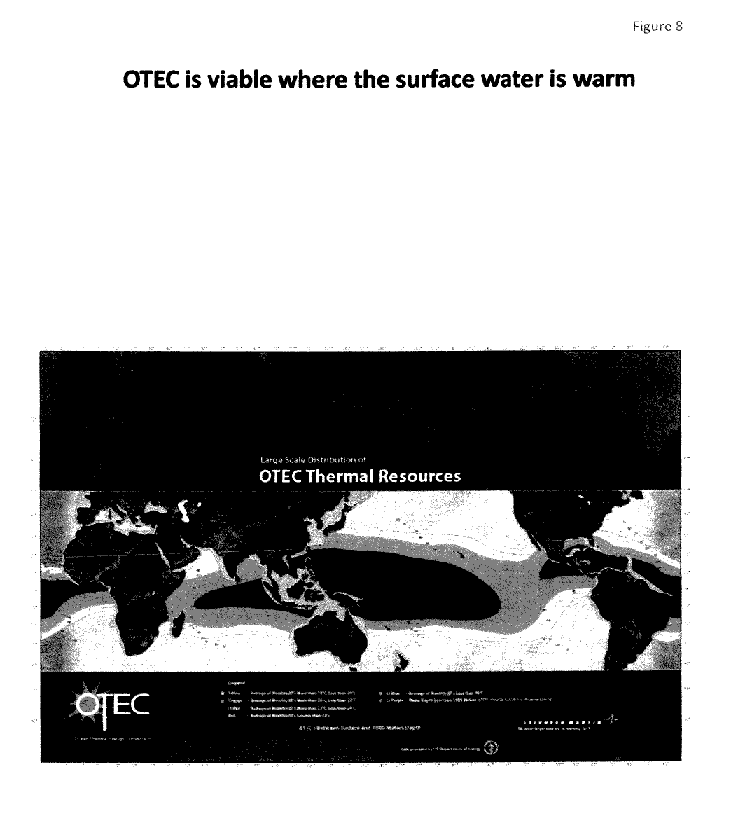

OTEC (FIG. 7) is a known and well-understood process (ref. 5, 6) which takes advantage of the natural temperature gradients in the ocean to generate clean renewable energy (and in some versions, potable water also), with no consumption of external fuels and no emission of greenhouse gasses. It is most useful in the tropical portions of the world (FIG. 8) operating day and night and in all weather conditions and is therefore especially useful for “dispatchable” or “baseload” energy generation. Small experimental OTEC plants have been built and operated successfully and have validated the governing theory, but because of the huge capital investments involved, the process has never been commercialized at the large scale (on the order of 100 MW per plant) that is required for economical operations.

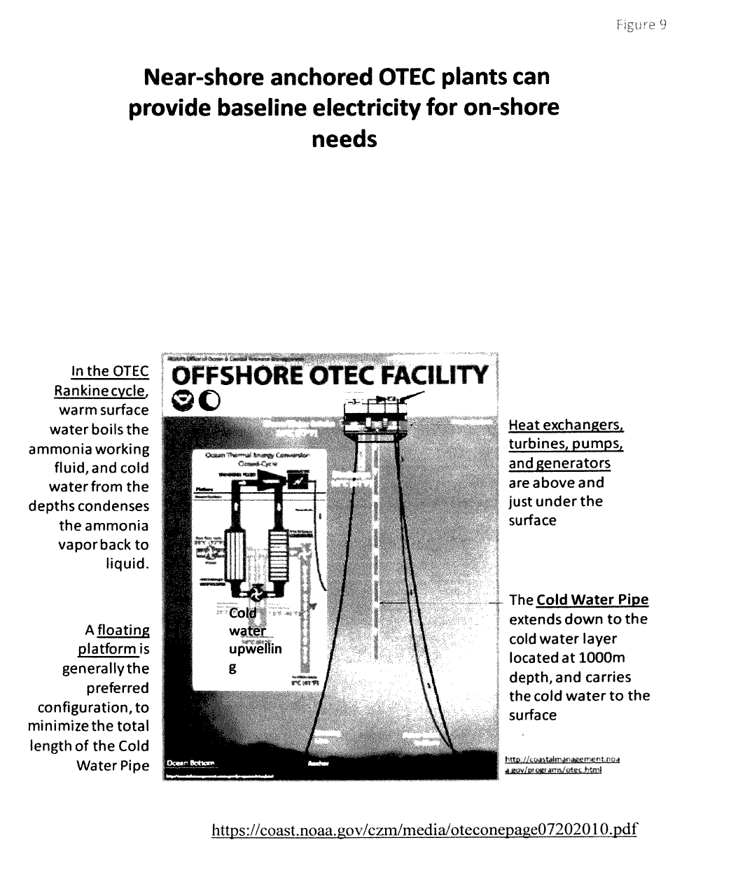

In the implementation generally envisioned'for large-scale OTEC, the machinery sits on a large platform that floats in the ocean (FIG. 9). Warm seawater is drawn in from the surface and passes through a heat exchanger, evaporating the working fluid (typically ammonia). The ammonia vapor has sufficient pressure to spin a turbine which is connected to a generator, thereby generating electricity. As in all such Rankine cycles, the vapor exiting the turbine must be condensed back to a liquid in order to be re-used, in a closed cycle. To accomplish the condensation, cold water is drawn up to the surface from the cold water layer which circulates within the world's oceans (at depths on the order of 1000 m), and is passed through a second heat exchanger. By placing the machinery on a floating platform, the “Cold Water Pipe” can be vertical and its length required to reach the required depth can be minimized.

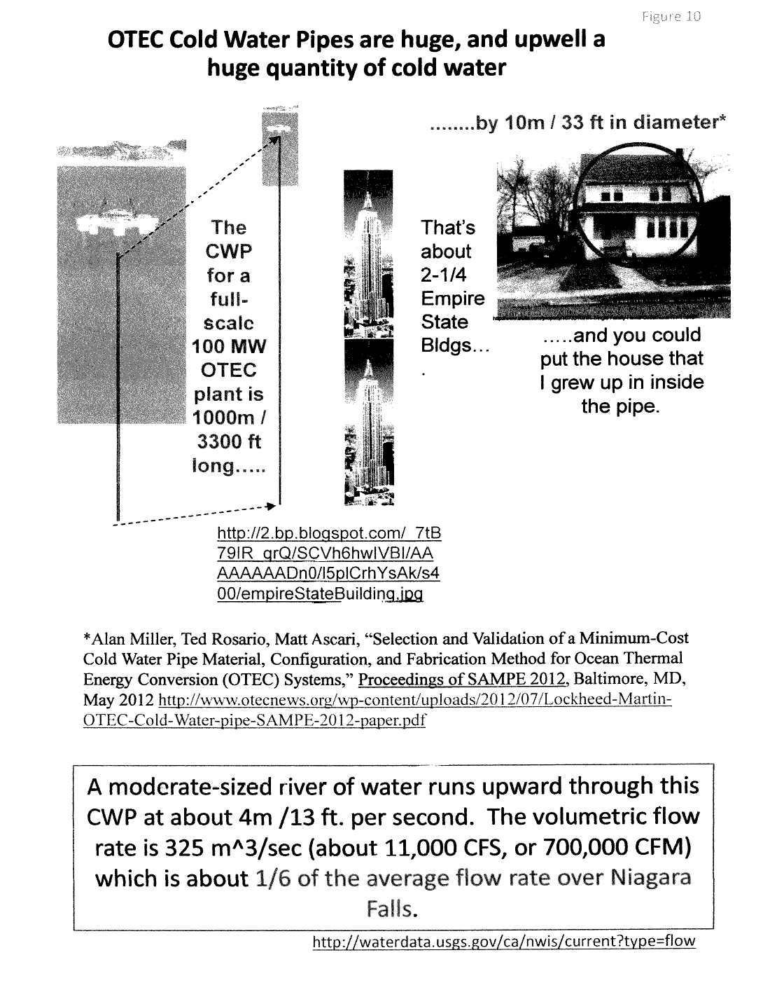

One of the reasons why the OTEC process has not attracted the required capital investment up until now has been the technical risk associated with the huge cold water pipe (FIG. 10), which has to be not only 1000 m long but also about 10 m in diameter for a 100 MW OTEC plant, or even 20 m in diameter for the 400 MW OTEC plants suggested in this work. This pipe upwells cold water at a huge volumetric flow rate. Recent work (ref. 7) has made major progress toward retiring that risk. This recent work has included large-scale hardware validation of the key elements of the new fabrication process that was invented to solve the problem.

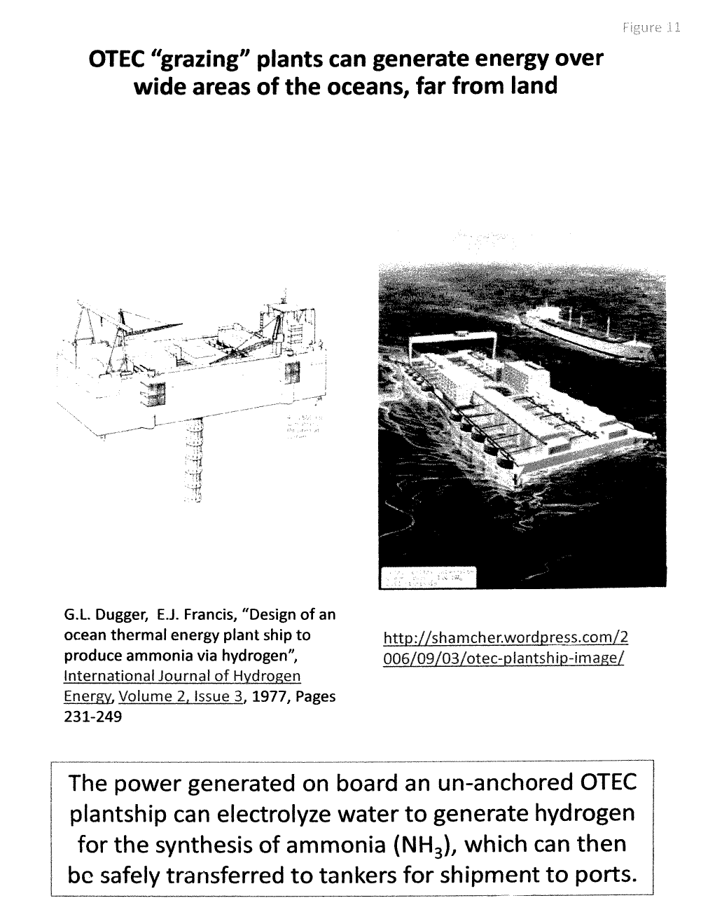

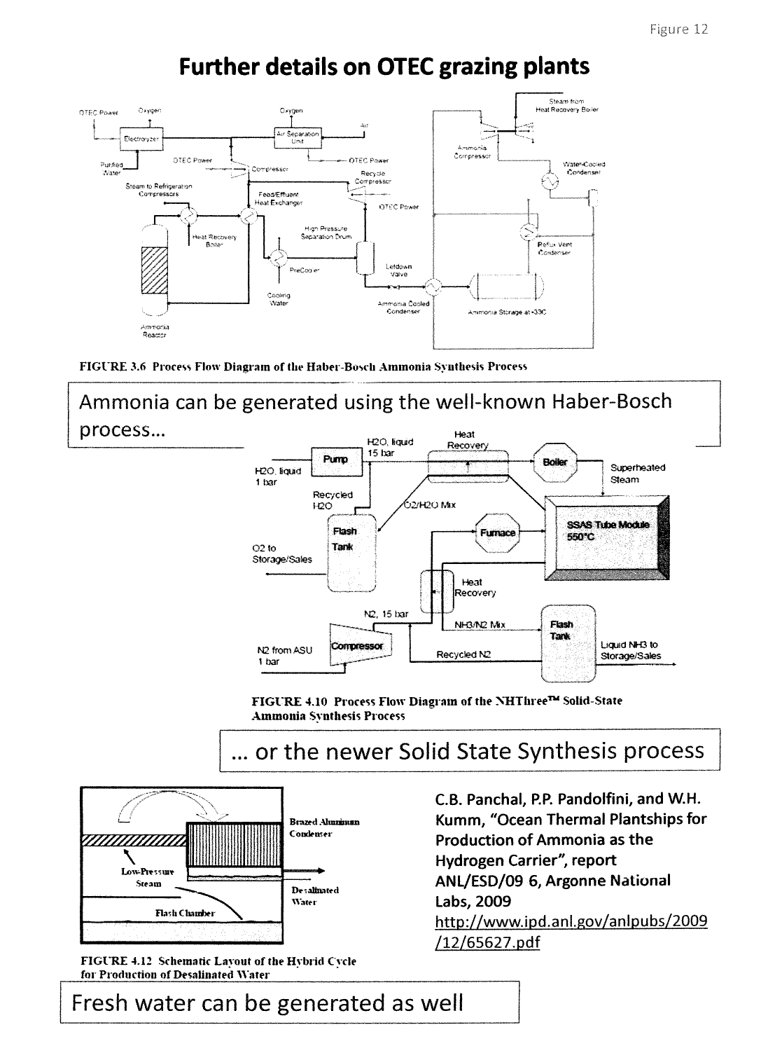

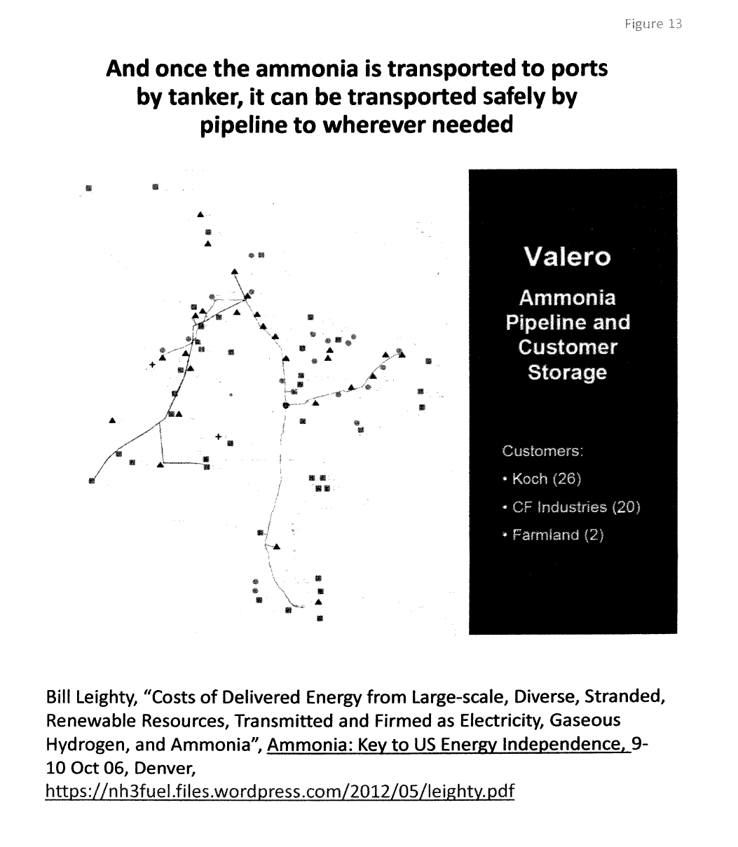

FIG. 9 showed an anchored OTEC plant located near shore and directly connected to the electric grid by a submarine cable. OTEC can also be deployed on a very large scale as open ocean “grazing” plant-ships (FIG. 11, 12). The most common form envisioned (ref. 8, 9) for capturing the “stranded” energy from this large number of grazing OTEC plant-ships is in the form of an energy carrier such as ammonia, which can be offloaded to tankers (FIG. 11) and transported to shore, then transported by pipeline to whoever it is needed (FIG. 13, ref. 11) and used for example as fuel for clean generation of central station electricity, as further described below.

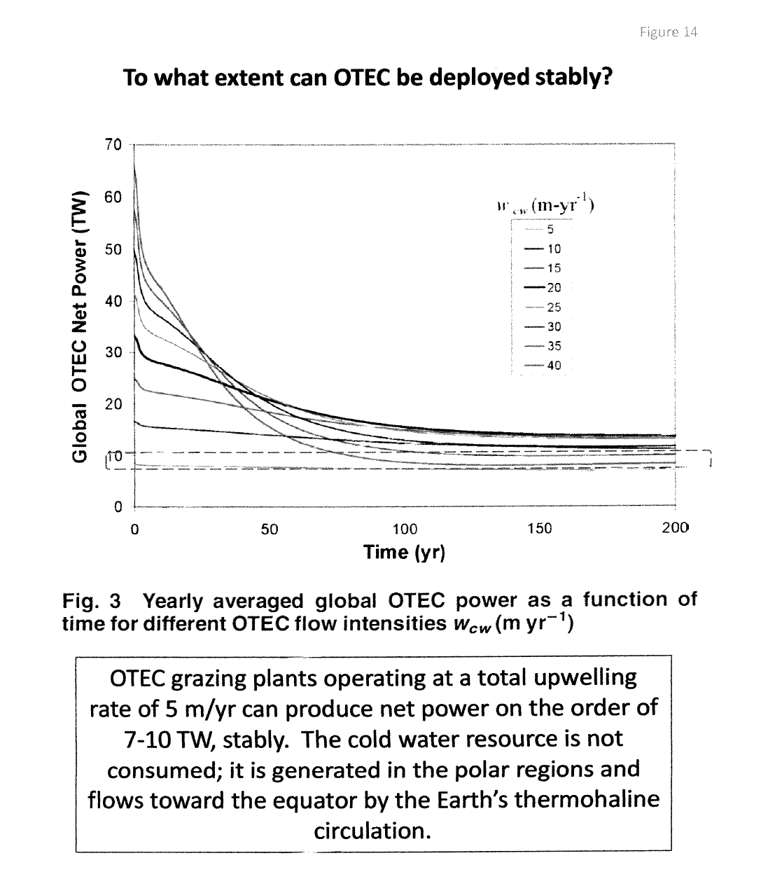

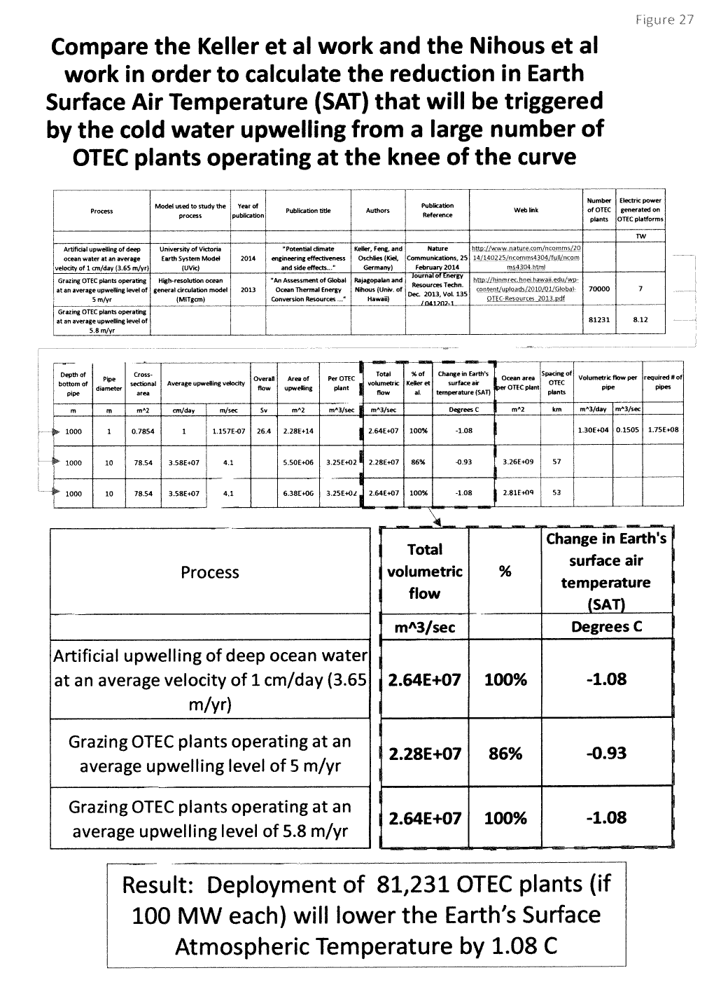

FIG. 14 (from work studying the large-scale deployment of OTEC using high-resolution Global Circulation Modelling of the world's ocean circulation, ref. 12) shows that large quantities of CO2-free electricity can be produced on the grazing plants in a stable manner, i.e. without causing large or continuing changes in the oceans' temperature field. Net power levels on the order of 7 to 10 TW (which would be 70,000 to 100,000 OTEC plants at 100 MW each) can be produced stably. This is equal to about half of the Earth's current total energy consumption. Such plants would be on the order of 57 km apart (see FIG. 27 below), far enough to not affect each other.

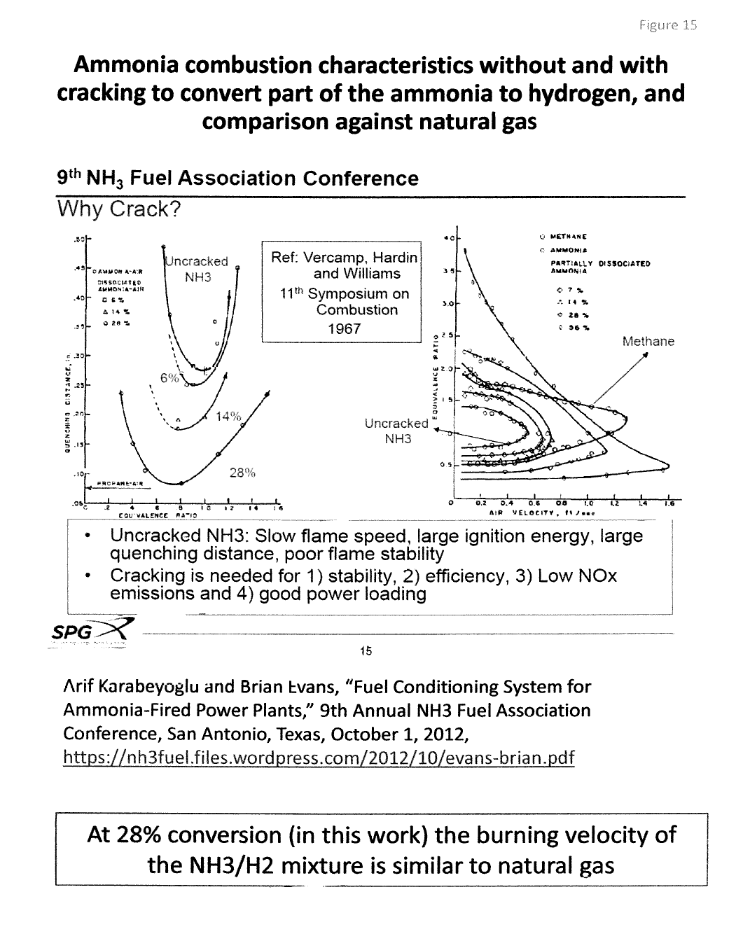

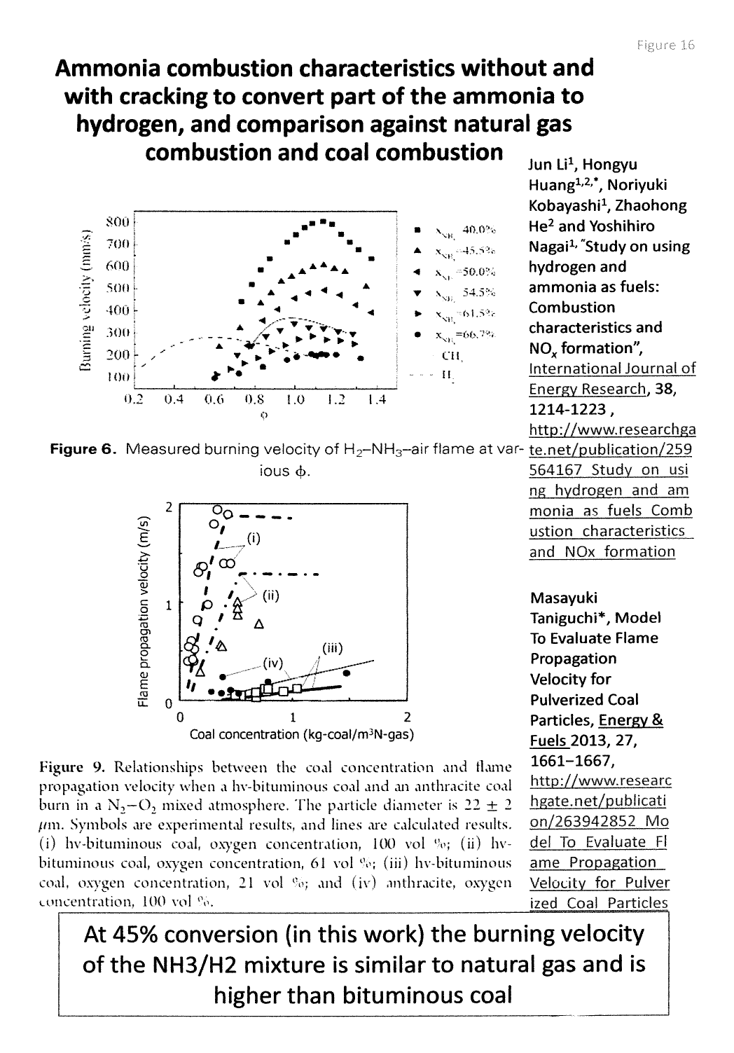

The transported ammonia is an energy carrier, but it has certain characteristics that prevent it from being a simple “drop-in replacement” for liquid or gaseous fossil fuels. The principal difference is flame speed. 100% ammonia has a flame speed that is too low to sustain combustion under the conditions prevalent in atmospheric-pressure boilers or ordinary gas turbine engines (FIGS. 15, 16). However “cracking” the ammonia to a mixture that is somewhere between 28% to 45% hydrogen produces a flame speed that is similar to that of natural gas [FIGS. 15 (ref 13) and 16 (ref. 14) enabling direct combustion of the mixture at atmospheric or elevated pressure.

Once cracked, the mixture will consist of ammonia gas and hydrogen gas. Given the difficulty of containing and transporting hydrogen, it is most desirable to utilize the cracked ammonia close to the point of cracking. This also allows waste heat from combustion to be used for the cracking process. For these reasons, it makes the most sense to locate the cracking equipment at central power plants that will generate CO2-free electricity, although other approaches to the utilization of the ammonia to replace fossil fuels are possible.

Since the ammonia can be stored near power plants, it can be drawn upon as fuel whenever and at whatever rate is desireable. Therefore the OTEC-generated power is “dispatchable” and can be used as a baseload source within the electric power system. This is a major advantage compared to “interruptible” renewables such as wind and solar, for which expensive storage schemes need to be implemented if they exceed a certain percentage (e.g. 30%) of the total system requirements. (ref. 15)

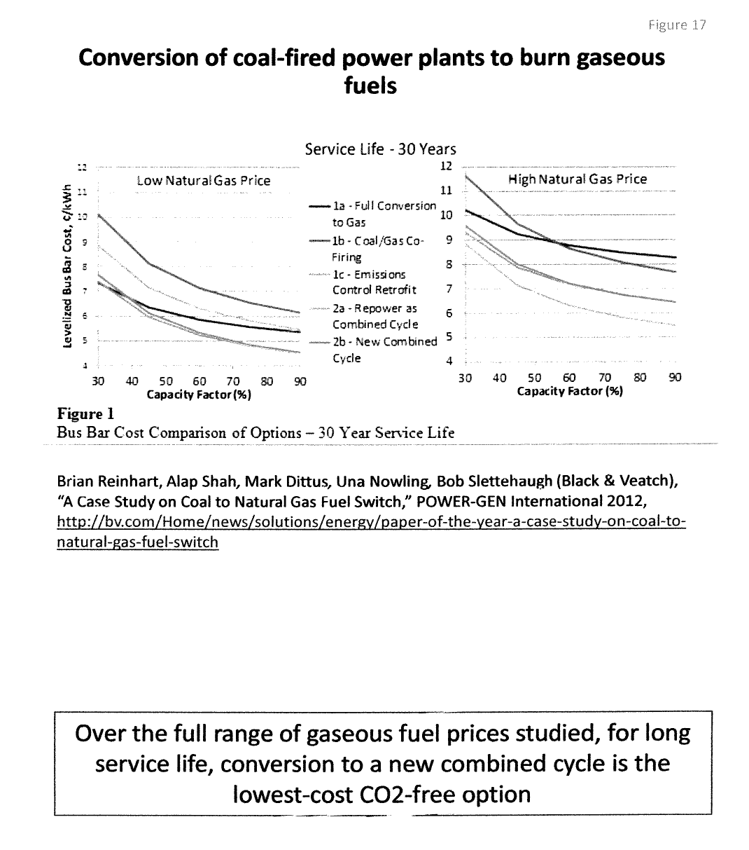

The ammonia-fueled power plants would not necessarily have to be new plants; they could for example be former coal-burning plants converted to burn gaseous fuel either by direct replacement of the coal-fired boiler to a gas-fired boiler, or by replacement of additional components to create a new combined cycle gas turbine/steam turbine unit operating at higher overall efficiency (FIG. 17, ref. 16)

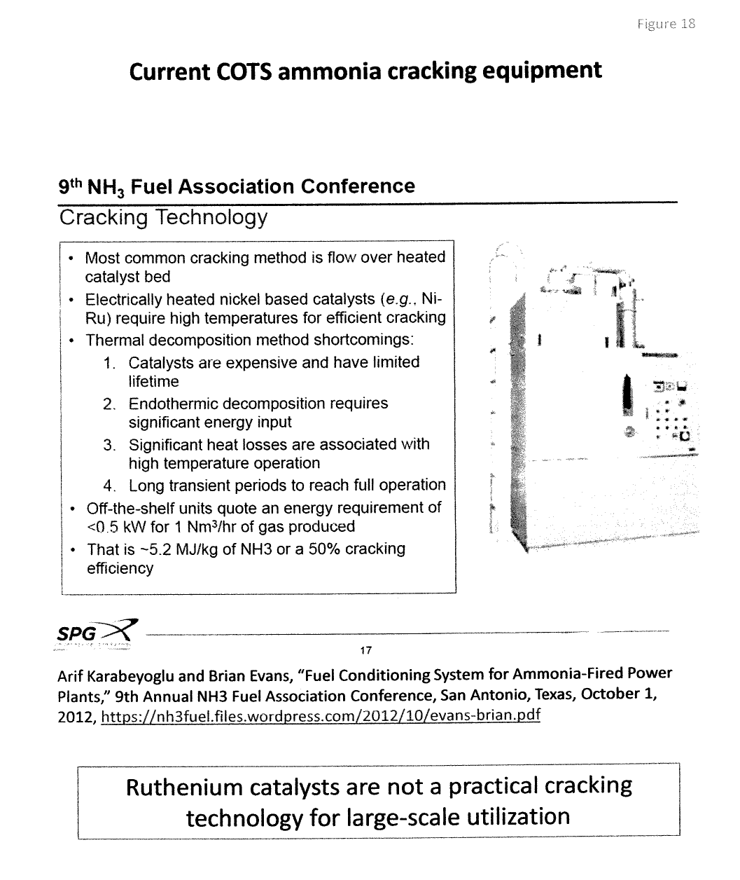

Up until recently, ammonia cracking has only been done at small scale, mainly for generating “forming gas” for metallurgical purposes. The equipment (FIG. 18) utilizes and consumes expensive Ruthenium catalysts and for that and other reasons would be impractical for cracking the large quantities of ammonia that would be involved in the approach described above.

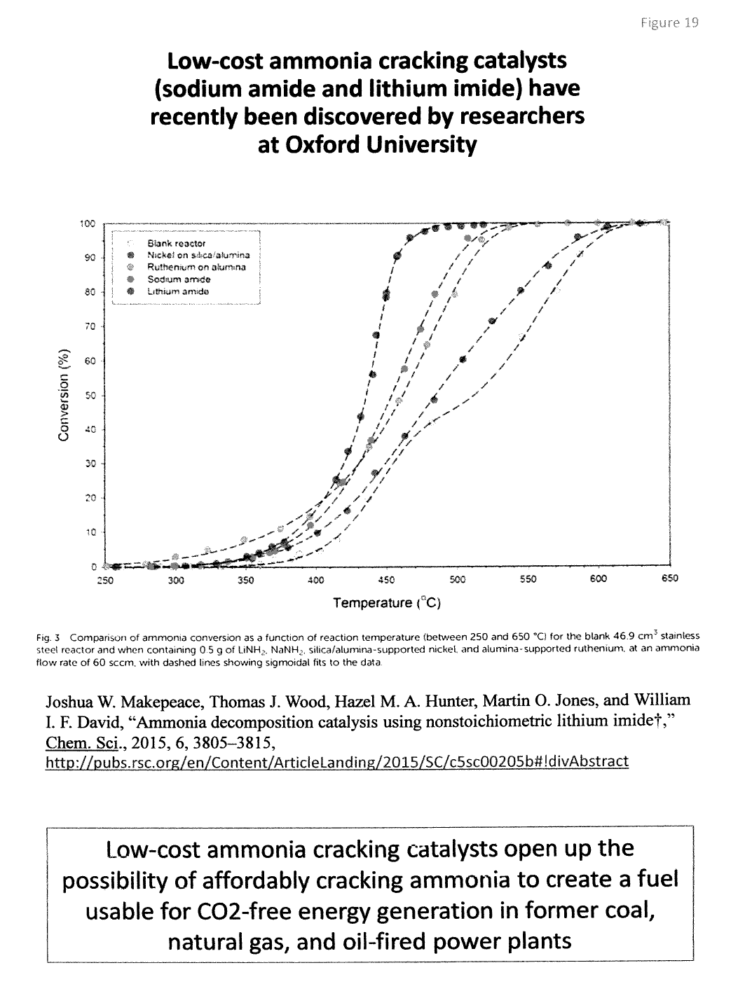

Fortunately, recent advances in ammonia cracking catalysts have produced the low-cost catalysts sodium amide and lithium imide (FIG. 19, ref. 17). These are very promising as the catalysts for cracking OTEC-produced ammonia at large scale.

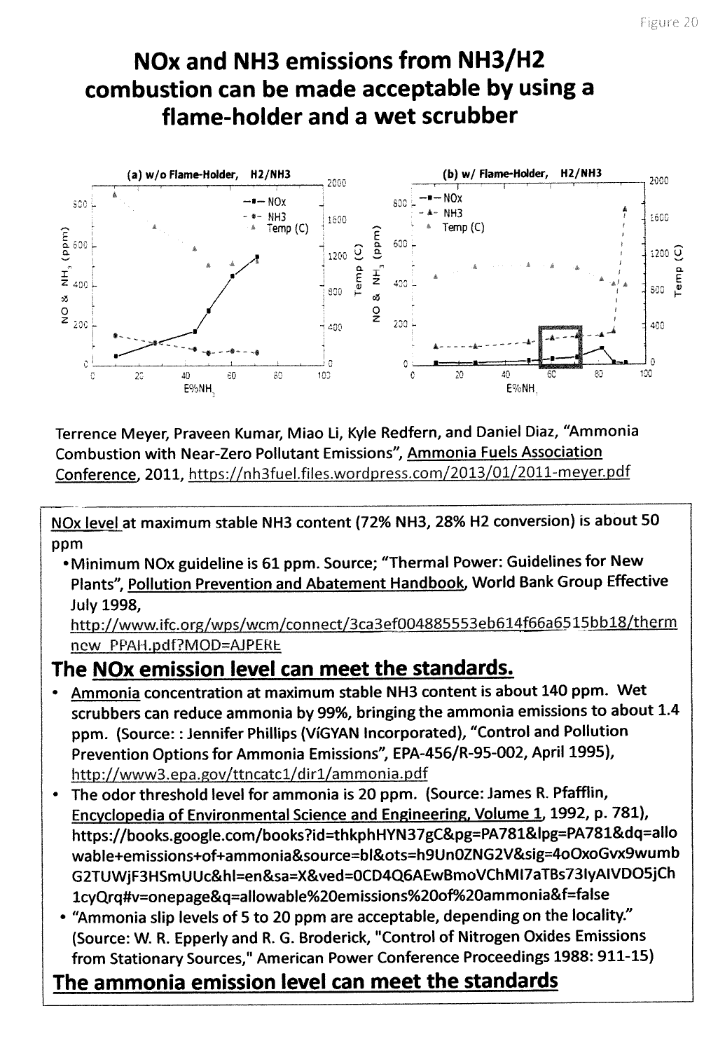

Use of ammonia as a power plant fuel brings up the question of what gasses would be emitted by such power plants. Another piece of recent research provides the answer: At the anticipated percentage range of ammonia in the ammonia/hydrogen mixture (55% to 72%), a flame-holder keeps the NOx emissions within normal guidelines, and when wet scrubbing is used it also keeps the ammonia emissions within normal standards (FIG. 20, including references).

B. How, Why, and to what Extent will the Large-Scale Deployment of OTEC Reduce the Earth's Surface Atmospheric Temperature

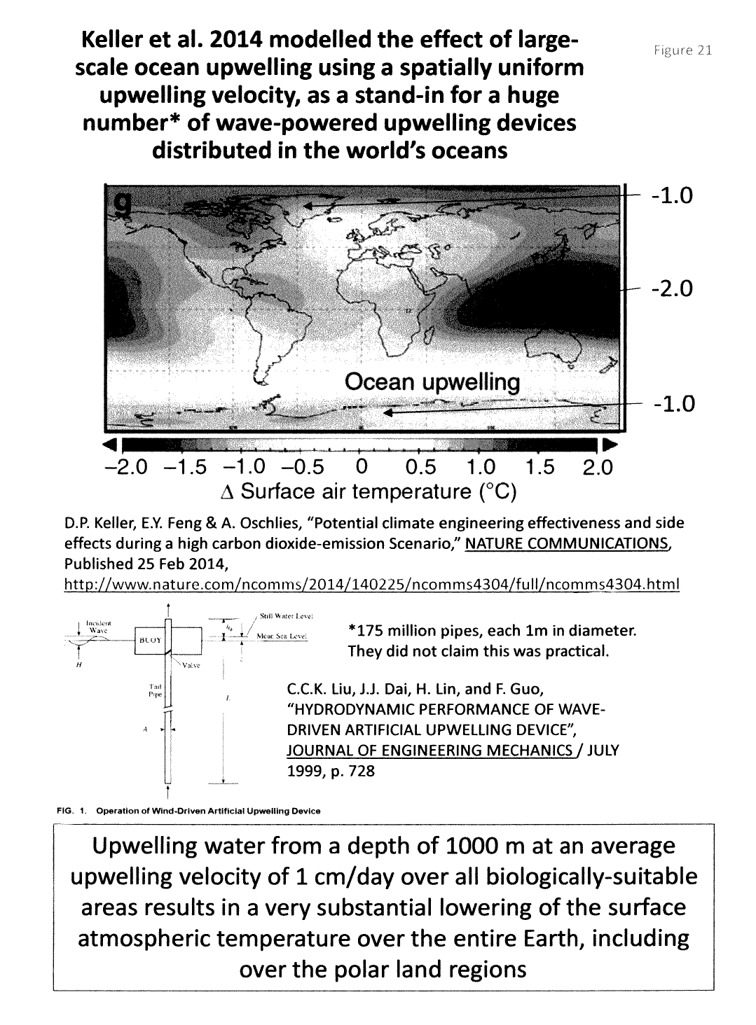

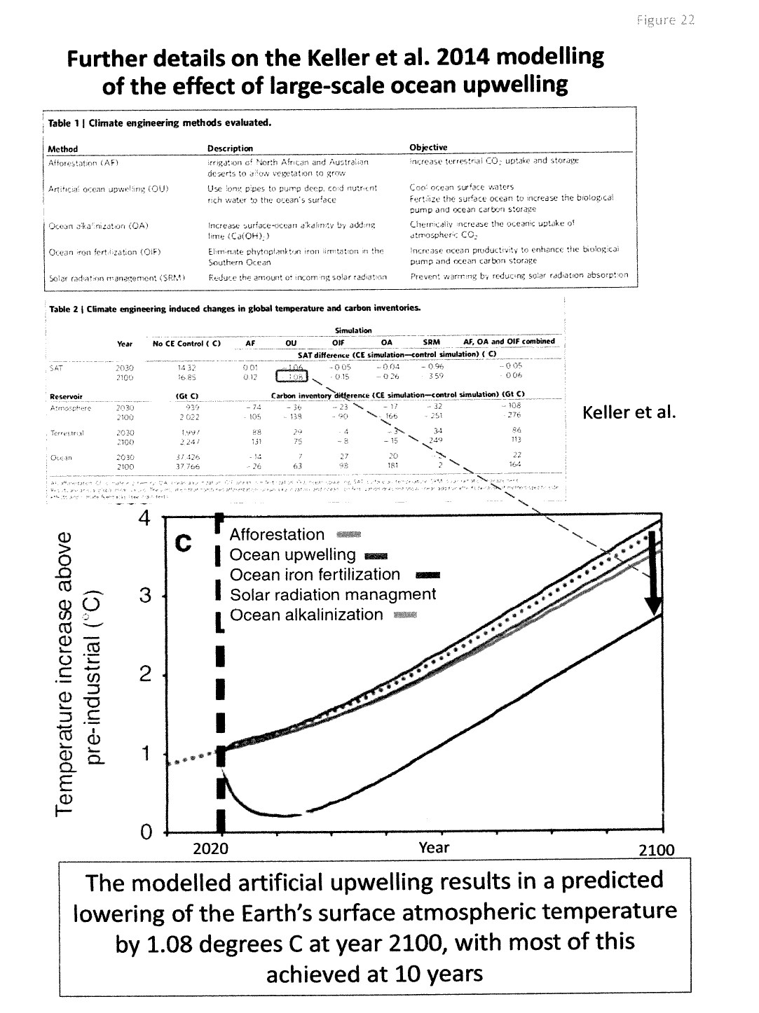

Independent of OTEC and never before connected to OTEC, it is now known (from Earth System Modelling studies conducted by others) that upwelling of large volumes of cold ocean water will cause a significant direct reduction in the Earth's surface atmospheric temperature (SAT), (FIG. 21, ref. 19)). For example, an upwelling of 1 cm/day from a depth of 1000 m over all of the biologically suitable areas of the oceans has been calculated to result in an SAT reduction of 1.08 C (FIG. 22) which would contribute very significantly to the mitigation of global warming.

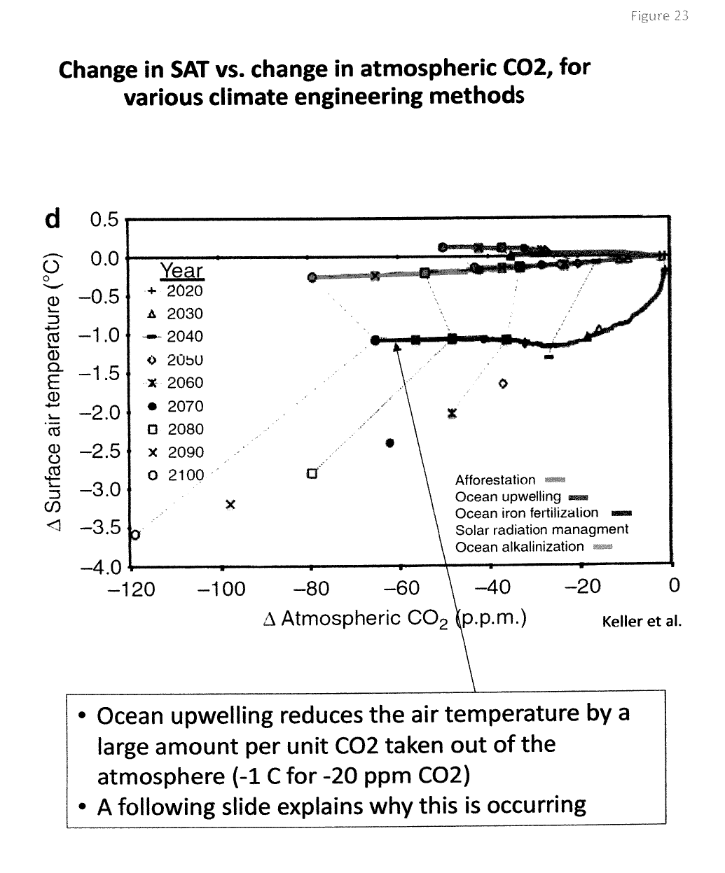

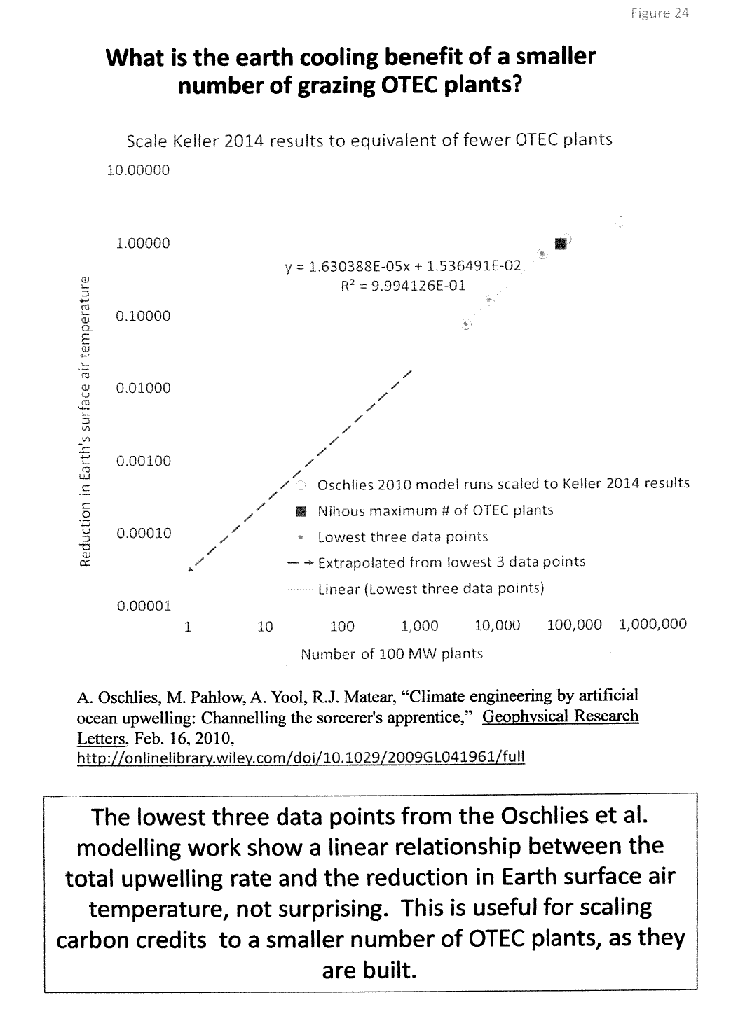

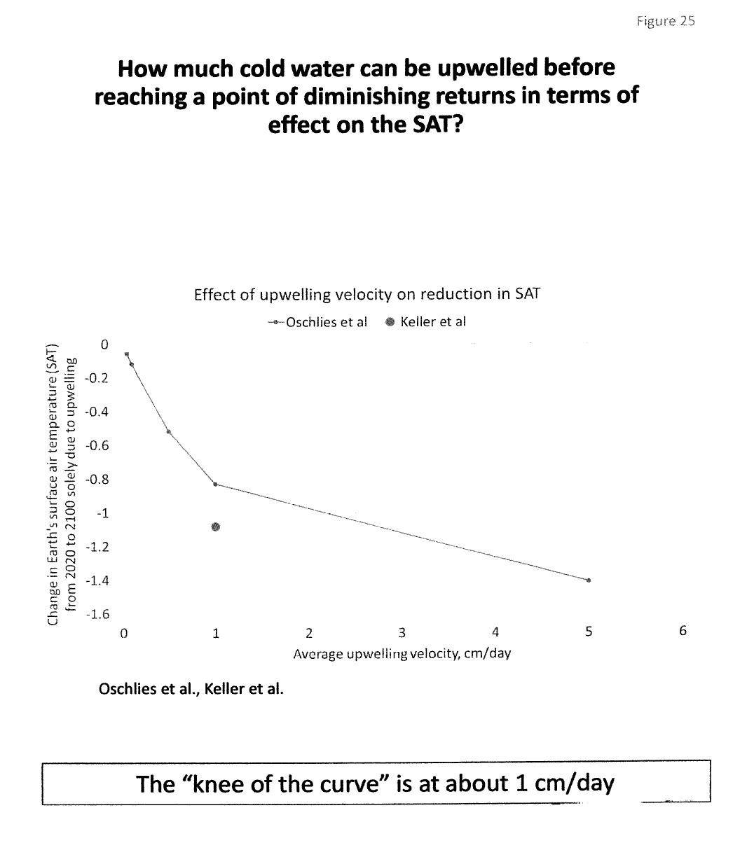

The effect is much larger than can be explained based on the reduction in atmospheric CO2 (FIG. 23) and is approximately linear with upwelling velocity up to about 1 cm/day (FIG. 24, ref. 20). The “knee of the curve” (often used as the most economic implementation point in engineering) of temperature reduction vs. upwelling velocity is at about 1 cm/day. (FIG. 25).

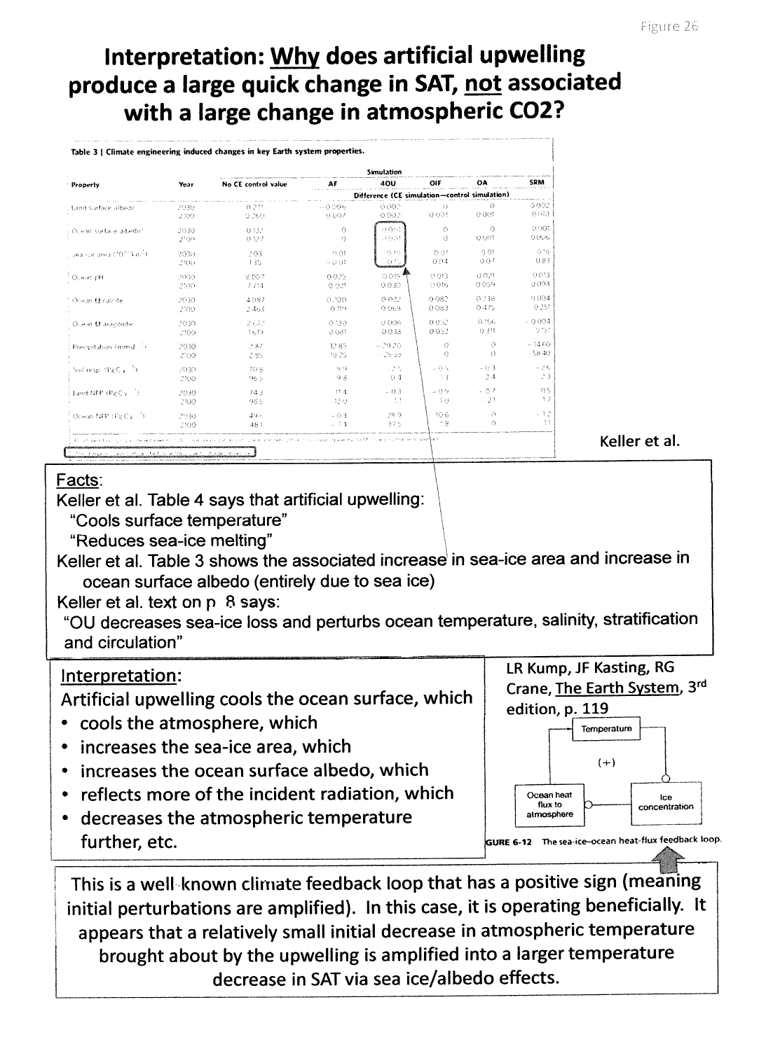

The Earth Systems Modeling results show that the temperature reduction that is produced is associated with an increased albedo associated with increased sea-ice coverage (FIG. 26). The reason for the surprisingly large reduction of the Earth's SAT, extending over the entire planet, appears to be that the cold water upwelling triggers a positively-signed climate feedback loop involving decreasing temperature, increased sea ice coverage, increased ocean albedo, further decrease in temperature, etc. This type of feedback loop is a general effect well-known in climatology (Ref. 21), (FIG. 26 lower left).

Now associating the separate pieces of prior work that have just been described (FIGS. 14 and 21): This inventor has calculated (FIG. 27) that the total rate of cold water upwelling by 81,231 OTEC plants at 100 MW each is the same as the total rate of cold water upwelling by 1 cm/day over all of the biologically suitable areas of the oceans as calculated by Keller et al. Therefore it follows that 81,231 OTEC plants could be expected to reduce the Earth's SAT by 1.08 C. Discovery of this new, non-obvious, and useful association is the basis for this invention.

This recommended implementation level for OTEC grazing plants (8.12 TW) is slightly higher than the 7 TW recommended by Rajagopalan and Nihous (ref. 12). The model used by Rajagopalan and Nihous considered only ocean circulation, and recommended a limitation to 7 TW based on calculated ocean surface temperature increases near Greenland (not wanting to accelerate the melting of land ice). However the Keller et al. calculations, which include air temperatures as well as ocean temperatures, show that the cold water upwelling actually decreases air temperatures in the polar regions (FIG. 21). Therefore implementation of this invention should slow down the melting of land ice, not accelerate it. The maximum recommended implementation level is based on the “knee of the curve” of SAT reduction vs. upwelling velocity (FIG. 25), not on ocean surface temperature increase. The details of arctic land ice melting under conditions that might include decreasing air temperature but increasing ocean surface temperature need further detailed study.

As stated in the background section and as will be shown below by calculation, this large SAT reduction could enable, within the costs and CO2 reductions agreed to at COP 21, reduction in global warming from the anticipated 2.6 C down to 1.52 C which would be well below the 2 C limit required to avoid environmental catastrophe. Hence this invention could be a major contribution to bringing global warming under control.

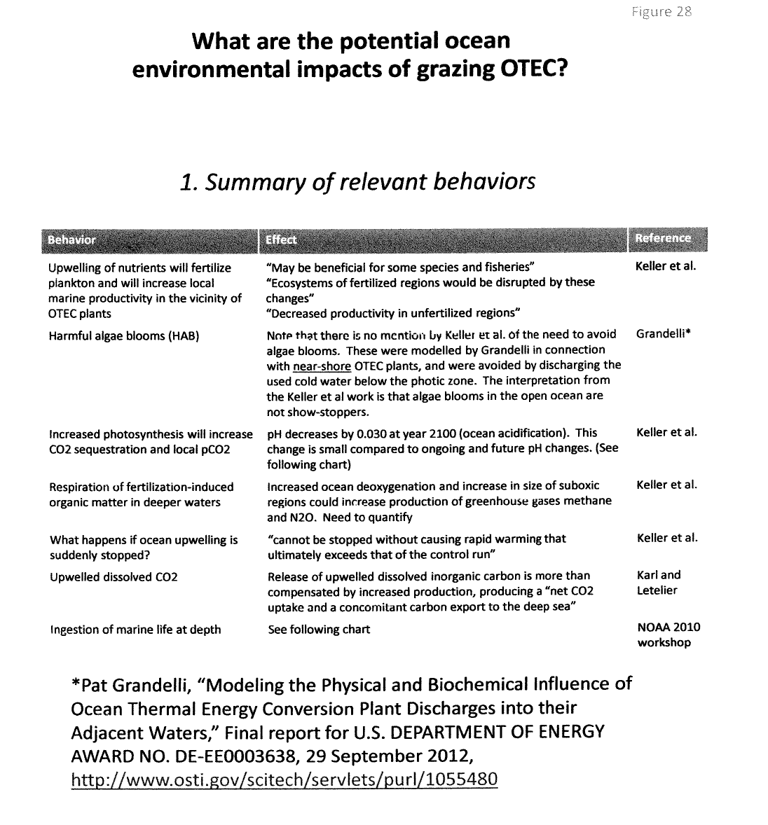

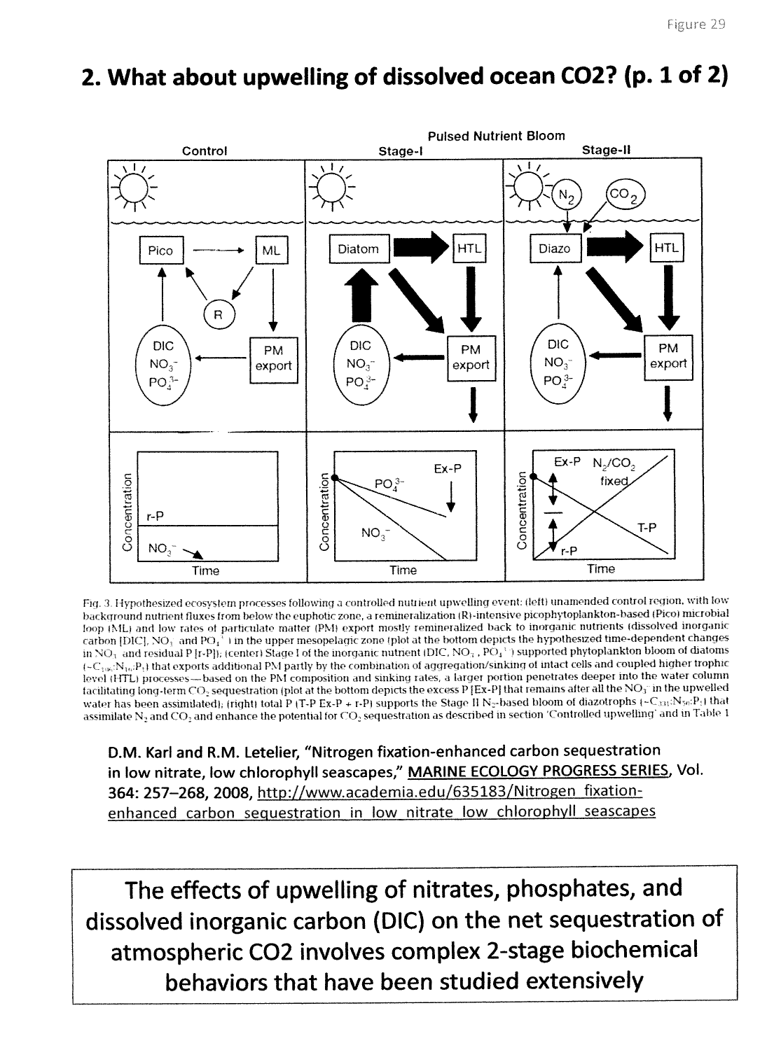

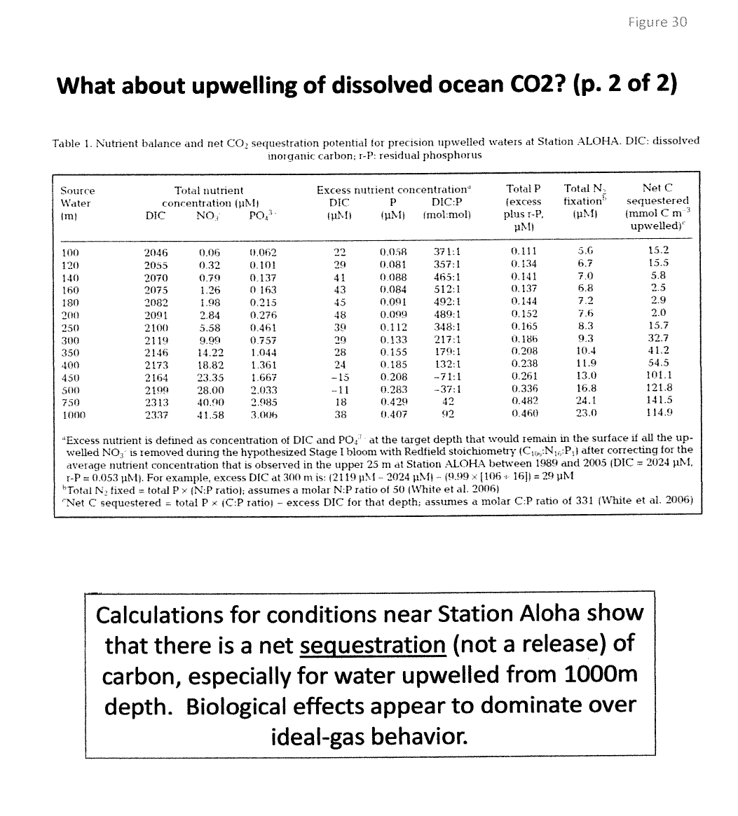

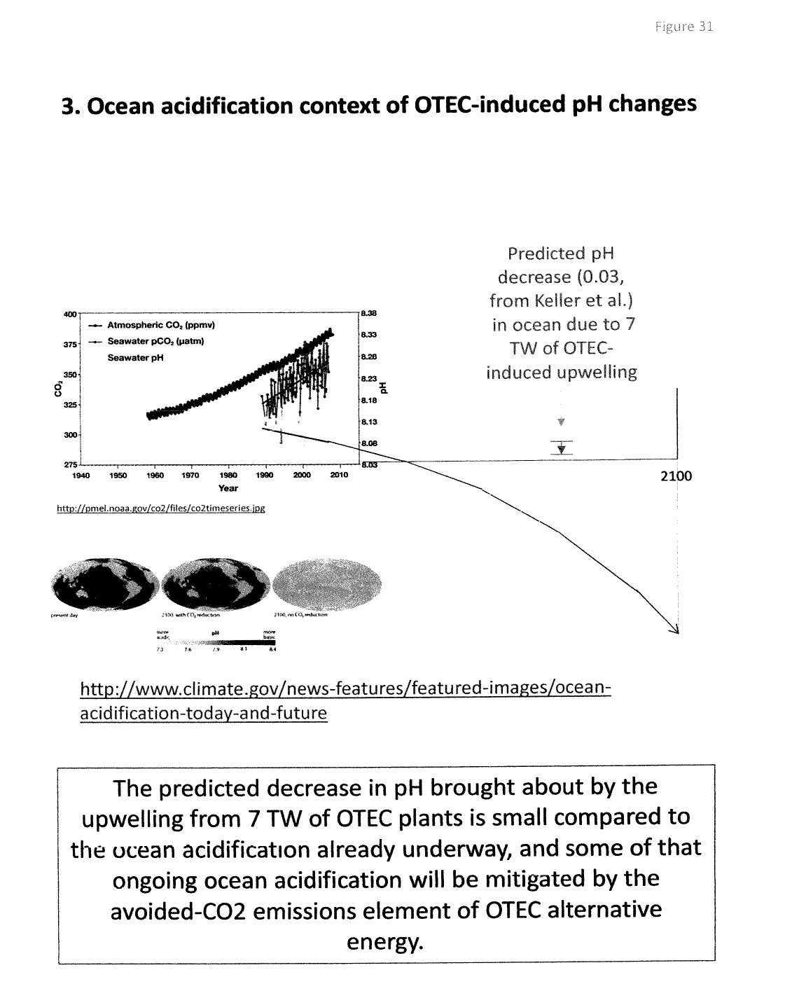

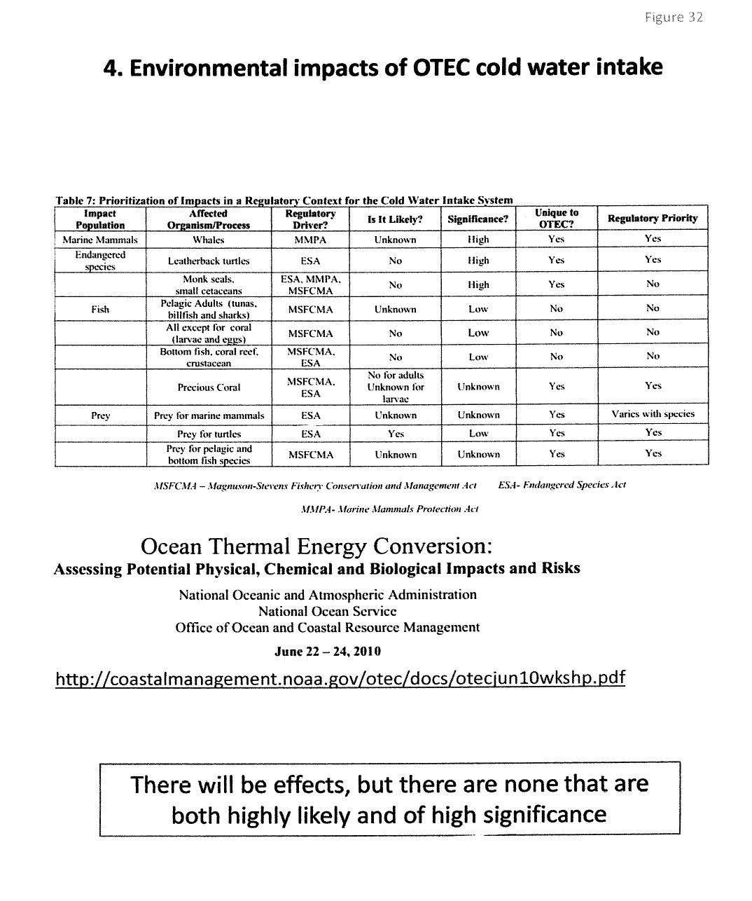

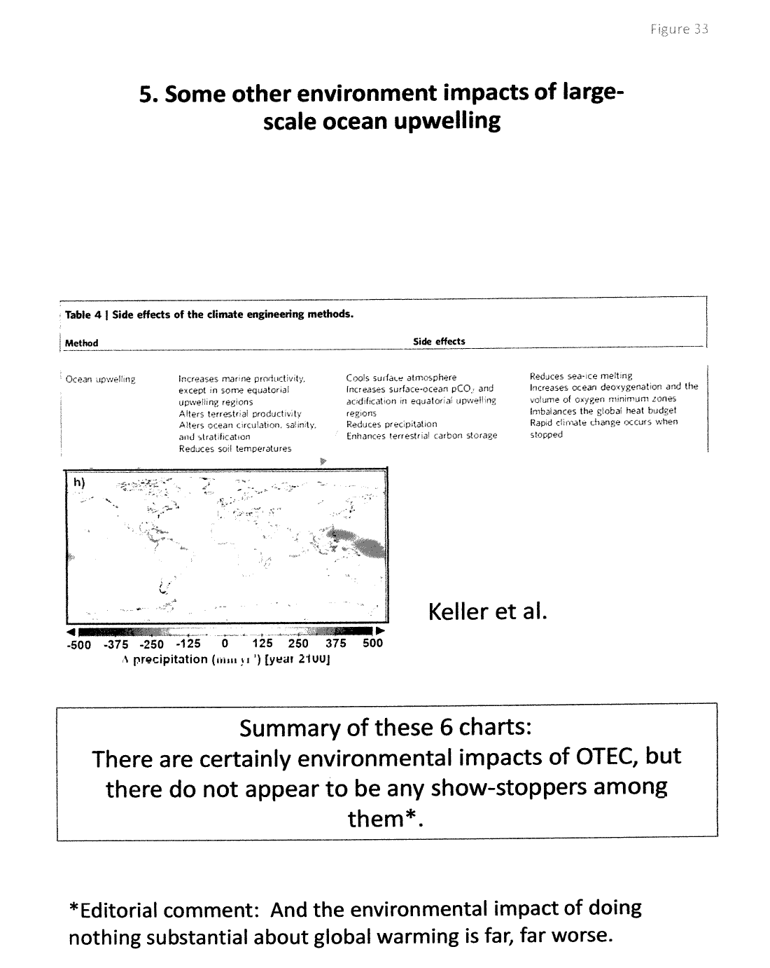

A brief examination of the possible environmental effects of this large number of OTEC grazing plants indicates that there are no obvious “show-stoppers” (FIG. 28-33, references on the figures) though further analysis and validation by experiment are certainly warranted.

Some additional information is provided here as other material that might be of interest with respect to the current invention. A journal paper (ref. 22) was published subsequent to the date of submitting the original provisional US patent application for this invention, but addressing the same general subject, namely what might be the effects on the Earth's climate of introducing a large number of OTEC plants into the oceans. That paper reached very different conclusions from the conclusions in this invention, because it used a very different and unrealistic modelling approach. Instead of actually modelling the cold water upwelling quantitatively (which was done in the published papers which form part of the basis for this invention, (ref. 12, 19, 20) that paper assumed in advance that the upwelling would disrupt the oceans' thermocline (the region between the surface and roughly 1000 m in depth over which the ocean temperature decreases strongly with depth) and as a shortcut it simply artificially increased the thermal diffusivity of the ocean in that region. In doing so, the temperature drop from the surface down to 1000 m depth was decreased arbitrarily from its original 15 degree C. value down to 3 degrees C., which is a totally unrealistic value compared to the several published studies which modelled the actual cold water upwelling; these showed that a temperature gradient of about 13 degrees C. is maintained even in the presence of upwelling at the magnitudes assumed in this invention. Proceeding with this totally unrealistic representation of the effects of the upwelling as input, Reference 22 then proceeded to calculate the effects of the disruption of the thermocline on the Earth's climate. These results and the conclusions that stem from them are of course totally unrealistic because the input was unrealistic. Accordingly, the results of ref. 22 have no bearing on the current invention.

C. How the OTEC-Induced Reduction in the Earth's Surface Atmospheric Temperature Leads to a Financial Strategy that Enables the Best Mode of Implementation to have Reasonable Electricity Rates and Minimum Investment Cost

To be worthwhile in the practical sense, the cost of implementing an invention must also be practical. In this case, the major reduction in SAT enables proposal of a financial strategy that could implement the invention at a capital cost that is lower than all other known approaches to the same problem, and lower than what the nations of the world expect to spend according to the INDC scenario. Accordingly, the financial strategy and predicted results are included in the description of the invention. The financial strategy capitalizes on the reduction in SAT to enable the governmental agencies that control CO2 emissions to award CO2 emission allowances to entities whose alternative energy technology implementations also produce direct reduction in Earth temperature. These emission allowances would be sold on the carbon credit markets to continued emitters of CO2, thereby raising most of the funds for construction of the OTEC system.

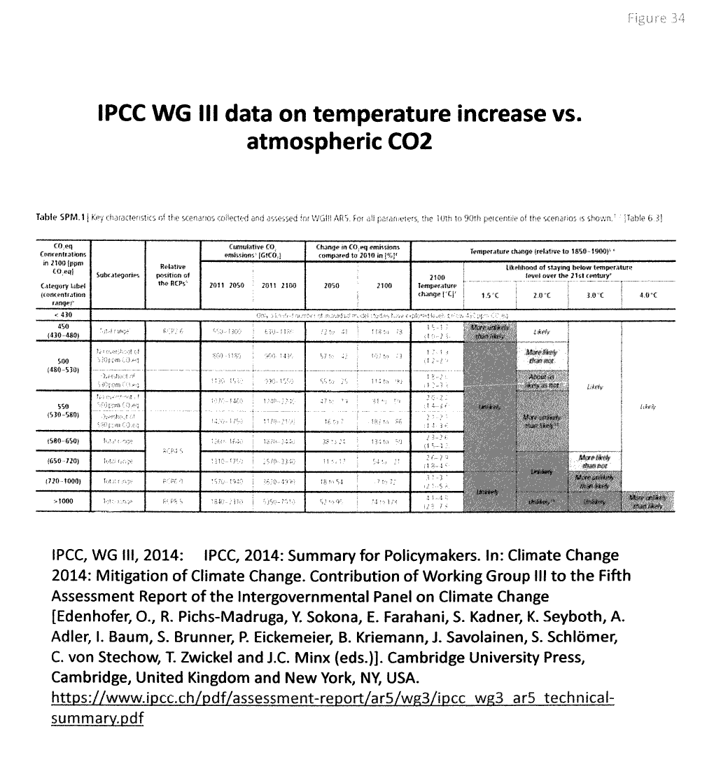

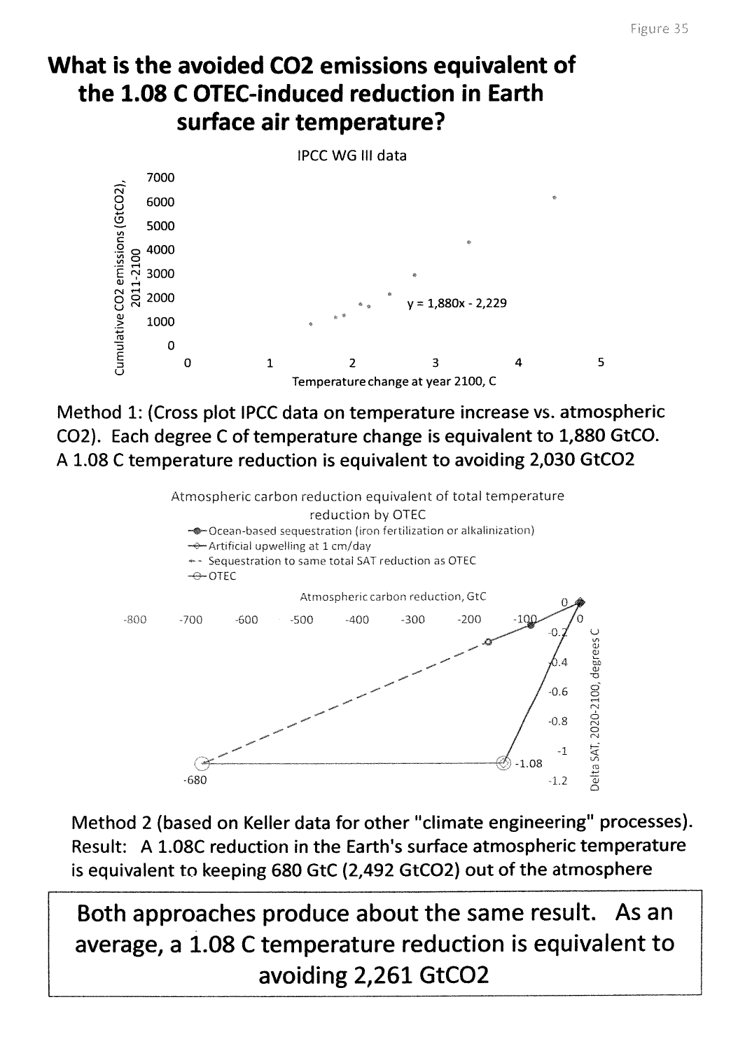

One key element in the financial strategy is calculation of the value of the expected 1.08 degree C. reduction in SAT in terms of an equivalent quantity of CO2 emissions that would have to be avoided in order to produce the same reduction in SAT. FIG. 34 provides one set of data with which to do this calculation, namely United Nations IPCC data on the various SATs that will be reached in year 2100 as a function of the atmospheric CO2 concentration. FIG. 35 (left) cross-plots these data, showing that each degree C. of temperature increase is equivalent to 1,880 GtCO emitted and therefore a 1.08 C temperature reduction is equivalent to avoiding 2,030 GtCO2. FIG. 35 (right) cross-plots the ocean iron fertilization and alkalinization data already shown in FIG. 23 to show that a 1.08 C reduction in the Earth's surface atmospheric temperature is equivalent to keeping 2,492 GtCO2 out of the atmosphere. Approximately the same answer is reached by both methods. Averaging these two results indicates that a 1.08 C temperature reduction is equivalent to avoiding 2,261 GtCO2.

The importance of the above calculation is that much of the world's emission of CO2 in many countries is now (or will soon be) “capped” by the cognizant regulatory agencies in each country (for example, the California Air Resources Board, the US Environmental Protection Agency, the US Regional Greenhouse Gas Initiative, the European Commission, the Chinese government, and others worldwide. The mission of these agencies is the mitigation of global warming. Thus far, the methods they have employed have been (1) enacting CO2 emission caps and running carbon credit markets by which capped emitters of CO2 can buy and sell CO2 emission allowances for cash in order to allow market forces to minimize the overall cost of reducing CO2 emissions, and (2) providing additional CO2 emission allowances (“offsets,” sellable for cash on the carbon markets) to entities that conduct additional activities which mitigate global warming by reducing atmospheric CO2 content (for example, planting new forests).

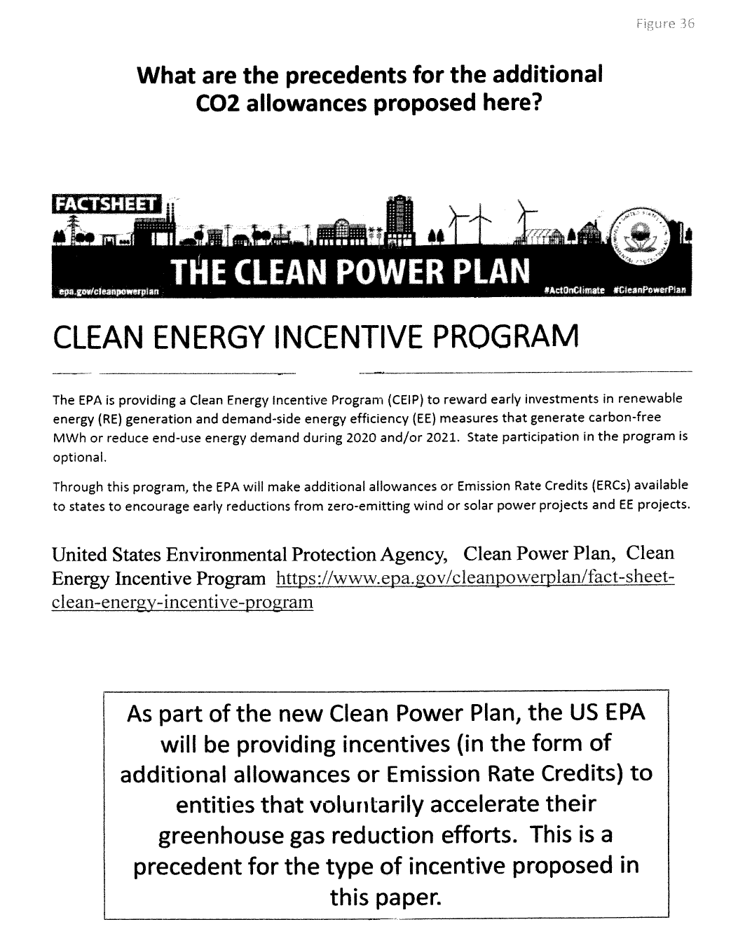

FIG. 36 shows an example of such incentives, from the US EPA Clean Power Program, in which additional CO2 emission allowances will be awarded to entities that reduce their emissions below the EPA requirements.

Although they have never had the opportunity to award CO2 emission allowances as incentives for activities that would cause a direct reduction in the Earth's SAT, it is believed that the cognizant agencies should be willing to do so as part of their overall mission of mitigating global warming. Getting the agencies to concur with such a plan is a critical future element in the implementation of this OTEC-based approach.

The linear behavior that was shown in FIG. 24 means that as each 100 MW OTEC plant is built, it would earn 1/81,231 of the overall 2,261 GtCO2 that is earned by reducing the SAT by 1.08 degrees C. This makes the incentive awards relatively easy to calculate.

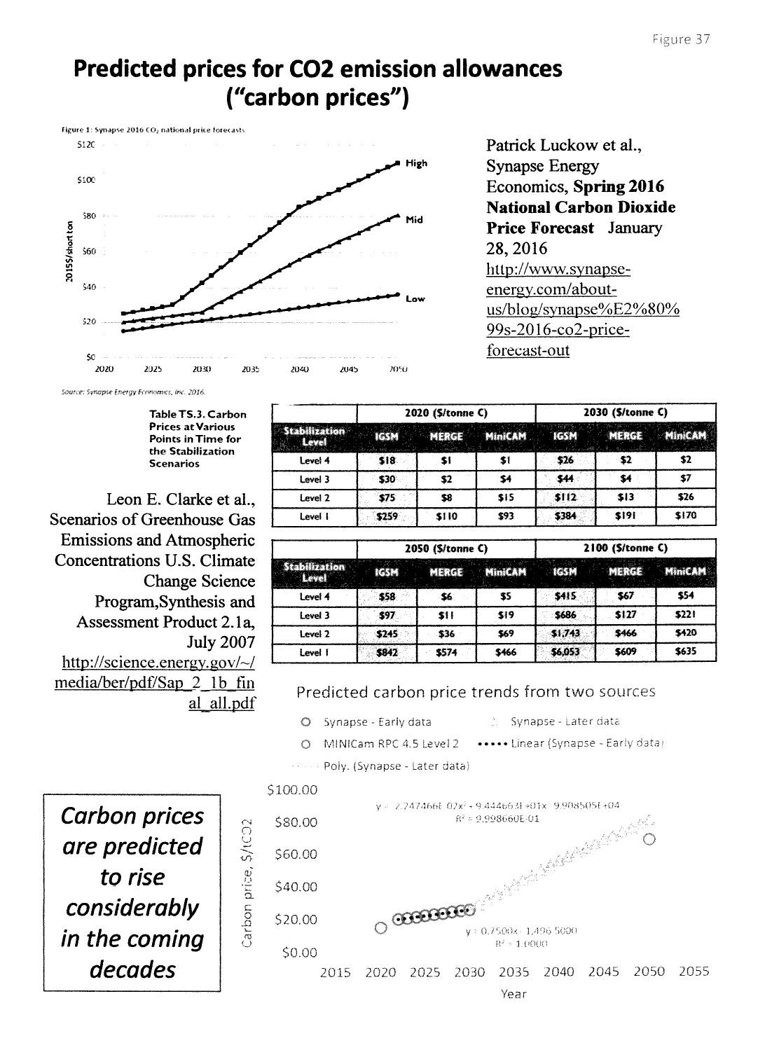

With this strategy, the actual unit cash value of the awarded CO2 emission allowances is important. FIG. 37 shows projections (from two different sources but reaching similar conclusions) of predicted carbon prices in the US (left) and worldwide (right). Prices are projected to reach $80/tCO2 by 2050, far above where they are today in most places.

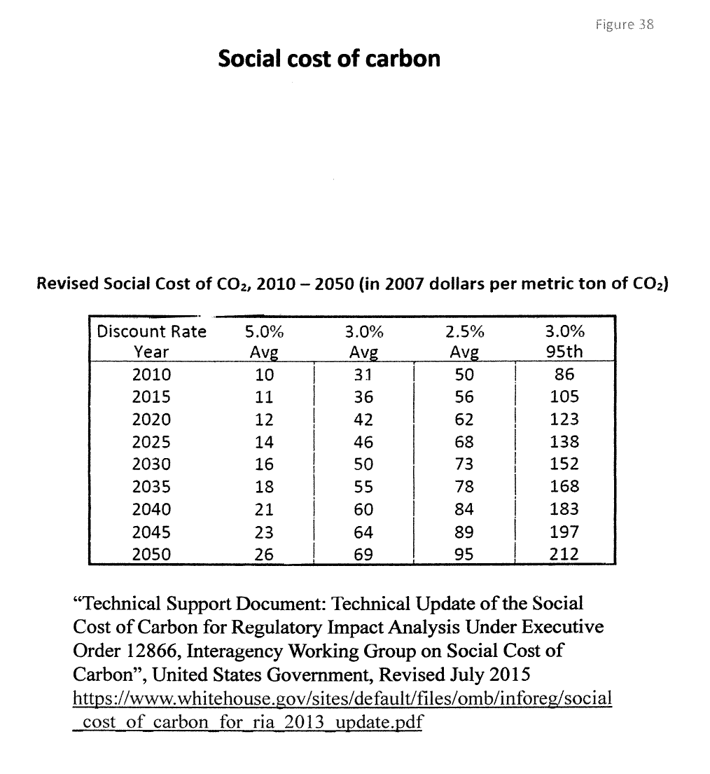

Another element that is important in calculating the benefits of the reduced SAT brought about by this approach comes under the heading of the “Social Cost of Carbon” (ref. 24). Generally the Social Cost of Carbon captures the negative impacts (sea level rise, health effects, etc.) of carbon-emitting activities, and FIG. 38 shows the values calculated by the US government. With respect to the present invention, the reduced SAT caused by the cold water upwelling becomes a reduced Social Cost of Carbon.

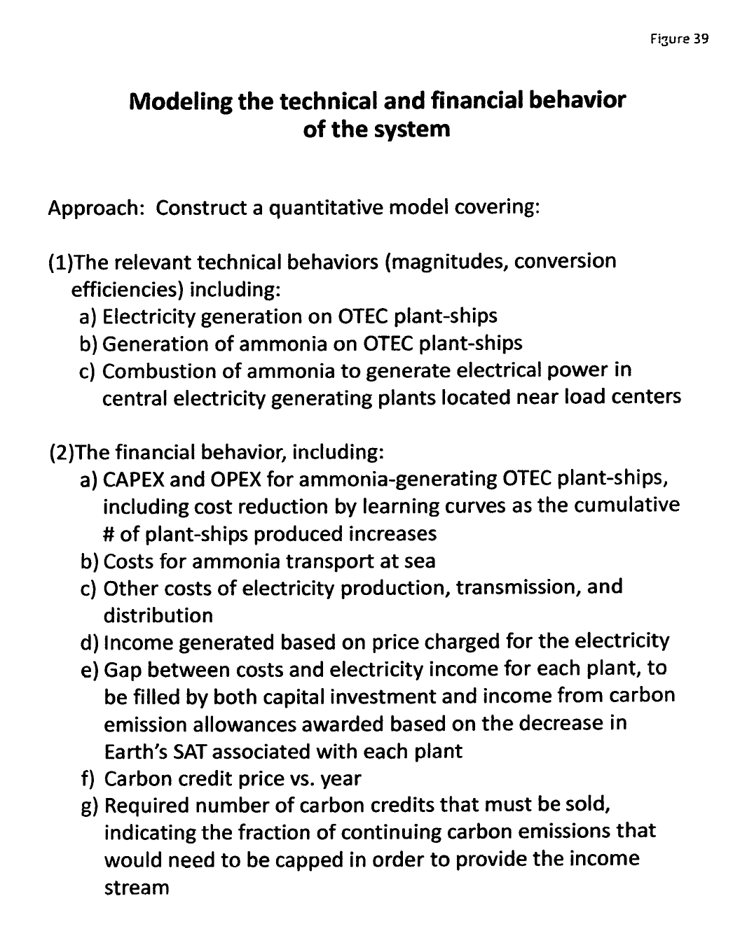

With this strategy and using currently available estimates of capital and operating costs for ammonia-producing grazing OTEC plants and other major cost elements, a computer model has been constructed to examine the technical and financial behavior of the system described. Its major elements are summarized in FIG. 39. This is a preliminary model, but its results are indicative of the rough magnitudes of the results that could be expected.

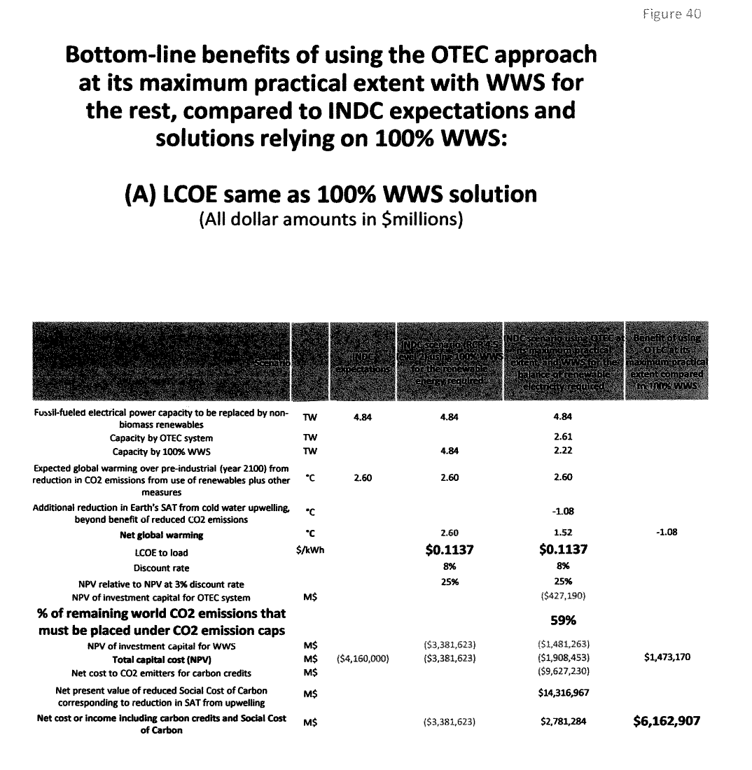

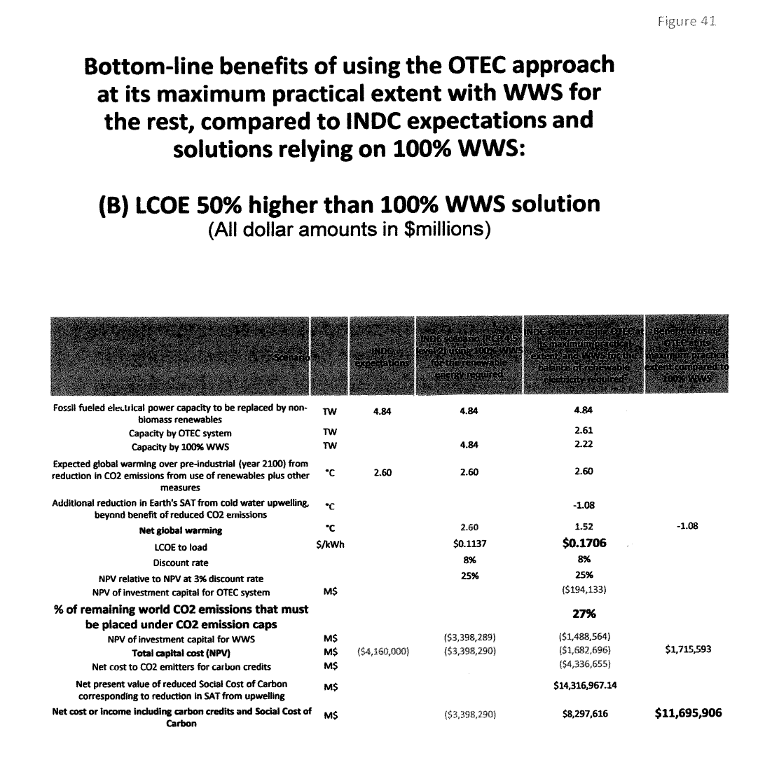

Detailed description of the model and its internal workings and the computer code are beyond the scope of this patent application since the model itself is not part of the claims (but they are available upon request). But to illustrate the potential usefulness and significance of the invention, some results of the current calculations are provided in FIGS. 40 and 41 and the current high-level conclusions follow in FIG. 41.

FIG. 40 assumes an electricity price (at the load) of $0.1137/kWh which is the same as that calculated by Jacobsen and colleagues (ref. 23) in studying a “100% Wind, Wave, and Solar” (100% WWS) electric power scenario for the US. FIG. 40 meets the need for renewable energy electricity per the INDC scenario, using OTEC to the maximum practical extent (at the knee of the curve in FIG. 25) with WWS for the rest. The current calculated result is that the capital cost with the OTEC+WWS approach (under $2 trillion) would be considerably lower than both that anticipated in the INDC scenario (over $4 trillion) and that calculated in the 100% WWS scenario for the same electric power capacity (over $3 trillion). However 59% of the world's remaining CO2 emissions would have to be placed under CO2 emissions caps in order to generate the revenue to finance the OTEC-based system. That is not impossible, but could be a considerable challenge.

FIG. 41 is a similar analysis to FIG. 40 but assumes an electricity price 50% higher than in FIG. 40. This is a not-unreasonable price and is consistent with the concept that electricity prices may have to rise (but hopefully not too drastically) to cover some of the costs of mitigating global warming. The current calculated result with this assumption is that only 27% of the world's remaining CO2 emissions would have to be placed under CO2 emissions caps in order to generate the revenue to finance the OTEC-based system. That is much less of a challenge than in FIG. 40. The capital cost of the OTEC+WWS approach is still considerably lower than both that anticipated in the INDC scenario and that calculated in the 100% WWS scenario for the same electric power capacity.

Insofar as it is known at this time, grazing OTEC plants located in international waters would not have to obtain permits from any specific entity. They would of course comply with all international laws, regulations, and best practices concerning safe and environmentally sound at-sea procedures. Since obtaining permits for wind, wave, and solar power projects often adds considerable complexity, cost, and time to their implementation, this provides another substantial advantage for grazing OTEC as a source of CO2-free electric power.

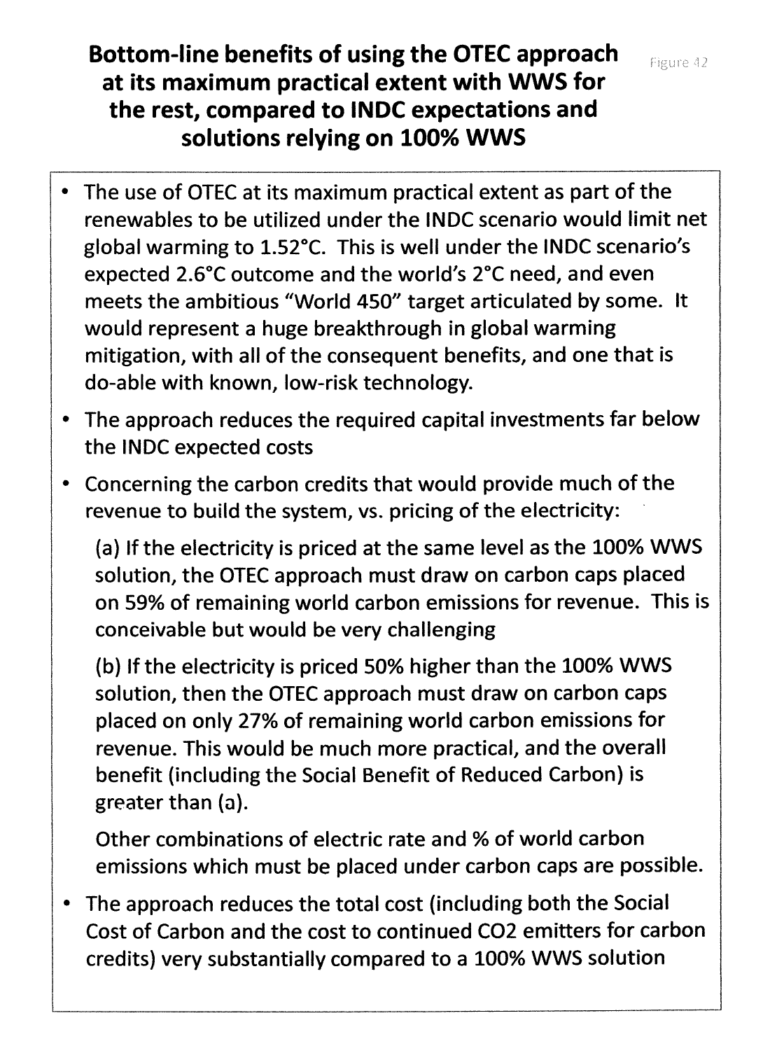

FIG. 42 summarizes the overall bottom-line benefits of using the OTEC approach at its maximum practical extent with WWS for the rest, compared to INDC expectations and solutions. These calculated benefits are provided to illustrate the behavior of the invention, using the preferred embodiment as described herein. The principal benefit is that the OTEC approach enables global warming to be held to 1.52 degrees C., instead of the 2.60 degrees C. which will occur under the INDC scenario even with 100% WWS for renewable power. In addition, the invention reduces the required capital investment far below the INDC expected costs. This should be a powerful incentive for implementation, on the part of both the governmental regulatory agencies that will have to provide the CO2 emission allowances, and private industry that will be able to earn a profit implementing the system.

Implementation of the invention incurs considerable costs (paid by continued CO2 emitters) for carbon credits. Again, this can be regarded as a necessary price to be paid for helping to mitigate global warming. However if the reduced “Social Cost of Carbon” (associated with the predicted benefits to humanity worldwide from reduced global warming, ref 24) is calculated (bottom three lines of FIGS. 40 and 41), this benefit outweighs the total value of the carbon credits paid by emitters.

### REFERENCES

1. “Effects of Global Warming,” National Geographic Magazine, http://environment.nationalgeographic.com/environment/global-warming/gw-effects/
2. Energy and Climate Change, International Energy Agency Special Report, 2015, https://www.iea.org/publications/freepublications/publication/WEO2015SpecialReportonEnergyandClimateChange.pdf
3. Global Carbon Budget 2015, Global Carbon Project, http://www.globalcarbonproject.org/carbonbudget/15/files/GCP_budget_2015_v1.pdf
4. Leon E. Clarke et al., “Scenarios of Greenhouse Gas Emissions and Atmospheric Concentrations,” Synthesis and Assessment Product 2.1a, Climate Change Science Program, July 2007 http://science.energy.gov/˜/media/ber/pdf/Sap_2_1b_final_all.pdf
5. James R. Chiles, “The Other Renewable Energy”, Invention & Technology, 23 (4): 24-35, Winter 2009
6. GEC Co, Ltd, OTEC Principle, http://www.otec.ws/otec_principle.html
7. A. K. Miller, T. Rosario, M. B. Ascari, “Selection and Validation of a Minimum-Cost Cold Water Pipe Material, Configuration, and Fabrication Method for Ocean Thermal Energy Conversion (OTEC) Systems,” Proceedings of SAMPE 2012, Baltimore, Md., http://www.otecnews.org/wp-content/uploads/2012/07/Lockheed-Martin-OTEC-Cold-Water-pipe-SAMPE-2012-paper.pdf
8. C. B. Panchal, P. P. Pandolfini, and W. H. Kumm, “Ocean Thermal Plantships for Production of Ammonia as the Hydrogen Carrier”, Argonne National Laboratory report ANL/ESD/09-6, August 2009, http://www.ipd.anl.gov/anlpubs/2009/12/65627.pdf
9 G. L. Dugger, E. J. Francis, “Design of an ocean thermal energy plant ship to produce ammonia via hydrogen”, International Journal of Hydrogen Energy, Volume 2, Issue 3, 1977, Pages 231-249

10. Shamcher Beorse, OTEC Plantship Image, https://shamcher.wordpress.com/2006/09/03/otec-plantship-image/
11. Bill Leighty, “Costs of Delivered Energy from Large-scale, Diverse, Stranded, Renewable Rcsources, Transmitted and Firmed as Electricity, Gaseous Hydrogen, and Ammonia”, Ammonia: Key to US Energy Independence, 9-10 Oct. 2006, Denver, https://nh3fuel.files.wordpress.com/2012/05/leighty.pdf
12. K. Rajagopalan and G. Nihous, “An Assessment of Global Ocean Thermal Energy Conversion Resources With a High-Resolution Ocean General Circulation Model,” Journal of Energy Resources Technology December 2013, Vol. 135, http://hinmrec.hnei.hawaii.edu/wp-content/uploads/2010/01/Global-OTEC-Resources_2013.pdf
13. Arif Karabeyoglu and Brian Evans, “Fuel Conditioning System for Ammonia-Fired Power Plants.” 9th Annual NH3 Fuel Association Conference, San Antonio, Tex., Oct. 1, 2012, https://nh3fuel.files.wordpress.com/2012/10/evans-brian.pdf
14. Jun Li, Hongyu Huang, Noriyuki Kobayashi, Zhaohong He and Yoshihiro Nagai, “Study on using hydrogen and ammonia as fuels: Combustion characteristics and NOₓ formation”, International Journal of Energy Research, 38, 1214-1223, http://www.researchgate.net/publication/259564167_Study_on_using_hydrogen_and_ammonia_as_fuels_Combustion_characteristics_and_NOx_formation
15. “Intermittent energy source”, Wikipedia, https://en.wikipedia.org/wiki/Intermittent_energy_source
16. Brian Reinhart, Alap Shah, Mark Dittus, Una Nowling, Bob Slettehaugh (Black & Veatch), “A Case Study on Coal to Natural Gas Fuel Switch,” POWER-GEN International 2012, http://bv.com/Home/news/solutions/energy/paper-of-the-year-a-case-study-on-coal-to-natural-gas-fuel-switch
17. Joshua W. Makepeace, Thomas J. Wood, Hazel M. A. Hunter, Martin O. Jones, and William I. F. David, “Ammonia decomposition catalysis using nonstoichiometric lithium imide†,” Chem. Sci., 2015, 6, 3805-3815, http://pubs.rsc.org/en/Content/ArticleLanding/2015/SC/c5sc00205b#!divAbstract
18. Terrence Meyer, Praveen Kumar, Miao Li, Kyle Redfern, and Daniel Diaz, “Ammonia Combustion with Near-Zero Pollutant Emissions”, Ammonia Fuels Association Conference, 2011, https://nh3fuel.files.wordpress.com/2013/01/2011-meyer.pdf
19. D. P. Keller, E. Y. Feng & A. Oschlies, “Potential climate engineering effectiveness and side effects during a high carbon dioxide-emission Scenario,” NATURE COMMUNICATIONS, Published 25 Feb. 2014, http://www.nature.com/ncomms/2014/140225/ncomms4304/full/ncomms4304.html
20. A. Oschlies, M. Pahlow, A. Yool, R. J. Matear, “Climate engineering by artificial ocean upwelling: Channelling the sorcerer's apprentice,” Geophysical Research Letters, Feb. 16, 2010, http://onlinelibrary.wiley.com/doi/10.1029/2009GL041961/full
21. L R Kump, J F Kasting, R G Crane, The Earth System, 3^{rd} edition, p. 119
22. Lester Kwiatkowski, Katharine L Ricke and Ken Caldeira, “Atmospheric consequences of disruption of the ocean thermocline,” Environ. Res. Lett. 10 (2015) 034016, http://iopscience.iop.org/article/10.1088/1748-9326/10/3/034016;jsessionid=DA9A7EC070A850CE3BED54BBD9F28268.c3.iouscience.cld.iop.org
23 Mark Z. Jacobson, Mark A. Delucchi, Mary A. Cameron, and Bethany A. Frew, “Low-cost solution to the grid reliability problem with 100% penetration of intermittent wind, water, and solar for all purposes,” 15060-15065|PNAS|Dec. 8, 2015|vol. 112|no. 49, http://www.pnas.org/content/112/49/15060
24 Technical Support Document: Technical Update of the Social Cost of Carbon for Regulatory Impact Analysis Under Executive Order 12866, Interagency Working Group on Social Cost of Carbon, United States Government, May 2013 https://www.whitehouse.gov/sites/default/files/omb/inforeg/social_cost_of_carbon_for_ria_2013_update.pdf

1. A process for mitigating global warming, comprising:
a large but environmentally-acceptable number of Ocean Thermal Energy Conversion (OTEC) grazing plants;
a large rate of cold water upwelling from the ocean depths, induced by the normal operation of the large but environmentally-acceptable number of Ocean Thermal Energy Conversion (OTEC) grazing plants;
a climate feedback loop including not only a decrease in ocean surface temperature from the upwelled cold water and a decrease in surface air temperature caused by the decrease in ocean surface temperature, but also an increase in sea ice coverage, an increase in average ocean albedo, and an increase in the percentage of incident radiation reflected away from the Earth's surface, all triggered by the OTEC-induced large rate of cold water upwelling from the ocean depths, that causes a substantial decrease in the Earth's average Surface Air Temperature (average SAT) relative to what the average SAT would be without this process being implemented, accruing many benefits from mitigating global warming, and also causes a substantial decrease in the Earth's SAT at locations far away from the OTEC plants, including over polar regions where the obtained reduction in SAT is particularly useful for obtaining the substantial benefit of slowing the melting of land ice, thereby slowing sea level rise; and
a number of OTEC plants that is sufficient to cause the resulting substantial reduction in the Earth's average SAT to be significant compared to well-known needs for SAT reduction associated with the mitigation of global warming.

2. The process recited in claim 1 in which, for example:
the large but environmentally-acceptable number of OTEC grazing plants is on the order of 20,308 OTEC plants generating 400 MW each (equivalent to 81,231 OTEC plants at 100 MW each);
the large rate of cold water upwelling from the ocean depths induced by normal operation of the large but environmentally-acceptable number of OTEC grazing plants is on the order of 2.64×10⁷ m³/sec;
the substantial decrease in the Earth's average SAT relative to what the average SAT would be without this process being implemented is on the order of 1.06° C. ten years after implementation, and 1.08° C. by year 2100, as calculated by an Earth Systems computer model for the example quantities listed above;
the increase in average ocean albedo from the process recited in claim 1 is on the order of 0.001, as calculated by an Earth Systems computer model for the example quantities listed above; and
the substantial benefit of slowing the melting of land ice is illustrated by (though it is not the same as) Earth Systems computer model calculations showing an increase in sea-ice area on the order of 0.10×10¹⁰ km² ten years after implementation and an increase in sea-ice area on the order of 0.15×10¹⁰ km² by year 2100, for the example quantities listed above, instead of a decrease in sea-ice area on the order of 0.68×10¹⁰ km² that will occur by year 2100 without this process being implemented, as calculated by the same Earth Systems computer model.

3. The process recited in claims 1 and 2 in which:
the increase in sea ice coverage and the increase in average ocean albedo as calculated and quantified by an Earth Systems computer model are due to a climate feedback loop in which the cold water upwelling causes a decrease in ocean surface temperature, which first causes a small decrease in SAT, which causes a small increase in sea ice coverage, which causes a small increase in average ocean albedo, which causes a small increase in the percentage of incident radiation reflected away from the Earth's surface, which causes a further decrease in SAT, which causes a further increase in sea ice coverage, and so on continuing in a climate feedback loop; and
in this way the decrease in ocean surface temperature produced by the cold water upwelling from the large but environmentally-acceptable number of OTEC grazing plants results in the substantial decrease (as calculated and quantified by an Earth Systems computer model) of the average SAT relative to what the average SAT would be without this process being implemented, and results in the substantial benefit of slowing the melting of land ice and thereby slowing sea level rise, and other benefits that accrue from mitigating global warming
